(19) United States
(12) Patent Application Publication
(10) Pub. No.: US 2020/0167834 A1
(43) Pub. Date: May 28, 2020

(54) INTELLIGENT IDENTIFICATION AND PROVISIONING OF DEVICES AND SERVICES FOR A SMART HOME ENVIRONMENT

(71) Applicant: Google LLC, Mountain View, CA (US)

(72) Inventors: Yoky Matsuoka, Los Altos Hills, CA (US); Mark Malhotra, San Mateo, CA (US); Shwetak Patel, Seattle, WA (US); Camille Dredge, Menlo Park, CA (US)

(73) Assignee: Google LLC, Mountain View, CA (US)

(21) Appl. No.: 16/618,542

(22) PCT Filed: Dec. 28, 2018
(86) PCT No.: PCT/US2018/068012

§ 371 Date: Dec. 2, 2019

Related U.S. Application Data
(60) Provisional application No. 62/611,067, filed on Dec. 28, 2017.

(51) Int. Cl. G06Q 30/02; G06Q 30/06; G06N 3/08; H04L 12/28

(52) U.S. Cl. CPC G06Q 30/0278; G06Q 30/0631; H04L 12/2812; G06Q 30/0261; G06N 3/08; G06Q 30/0271

(57) ABSTRACT

Described herein are systems and methods for intelligent identification and provisioning of devices and services for a smart home. A user can identify an issue or a question with respect to how to solve a problem within their home. The system can use advanced intelligence to interact with the user to obtain information that can allow the system to identify relevant information for solving the user's problem or answering the user's question by identifying correlated information about the user, such as demographic or behavioral information, and using that information in conjunction with past purchasing information, information specific to the user's home, and the like to generate a recommendation and installation plan for one or more smart home devices for the user. Once implemented, the system can also provide confirmation that the installation was completed properly.

### CROSS-REFERENCE TO RELATED APPLICATIONS

This application claims priority to and the benefit of U.S. Provisional Patent Application No. 62/611,067, filed Dec. 28, 2017, entitled “INTELLIGENT IDENTIFICATION AND PROVISIONING OF DEVICES AND SERVICES FOR A SMART HOME ENVIRONMENT,” of which is assigned to the assignee hereof, and which is incorporated in its entirety by reference for all purposes.

### BACKGROUND

Many homes now have smart devices thus creating a smart home environment. For example, thermostats that recognize when a user is home or away and automatically adjust the heating and cooling settings can make the home more energy efficient. Furthermore, users often face issues regarding their home that they are unsure how to solve or are overwhelmed by the available options. For example, a user may be concerned with energy efficiency, occupant safety, or home security. However, the user may not know what solutions exist to make a home more energy efficient, safe, or secure or how best to utilize the available options. While discussions with sales representatives may be useful, sales representatives can be inconsistent, leaving the user with differing suggestions and even more confused about the best options to choose. Sales representatives may also not be aware of the latest smart home products available. Further, the cost to provide personal sales assistance or user service from human representatives can be an excessive expense to companies. Additionally, the wait to speak with a human representative may cause the user to lose interest before even speaking to the representative.

### SUMMARY

Systems and methods are disclosed herein for providing intelligent identification and provisioning of devices and services for the smart home. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The system for intelligently identifying and recommending smart home products for a smart home environment may include a database. The database may include characteristic data from each existing user, choice data from each existing user, and performance metrics associated with the choice data for each existing user. The system may also include an artificial intelligence system capable of using supervised learning to generate at least one model based on the characteristic data, choice data, and performance metrics in the database. The artificial intelligence system may also be capable of identifying a fitted model from the generated models based on the initial parameter data. The fitted model may be identified in response to receiving notification of a triggering event that includes the initial parameter data. The triggering event may be associated with a prospective user. The artificial intelligence system may also be capable of extracting interview questions based on the fitted model. The artificial intelligence system may also use reinforcement learning to map response parameters of the prospective user to characteristic data in the database to generate, using choice data and performance metrics associated with the mapped characteristic data, a product recommendation including one or more smart home products for the prospective user. The response parameters may include interview responses of the prospective user to the interview questions. The artificial intelligence system may also use reinforcement learning to update the database to include the prospective user in the population of existing users with characteristic data and choice data of the prospective user in response to receiving a success metric for the prospective user. The success metric may be stored in the database as the performance metric associated with the choice data of the prospective user. Other embodiments of this aspect include corresponding computer systems, apparatus, and computer programs recorded on one or more computer storage devices, each configured to perform the actions of the methods.

Implementations may include one or more of the following features. The system may also include a server application executed by a computer of the system. The server application may be configured to provide a user interface to interact with the prospective user. The server application may also be configured to transmit, via the user interface, the interview questions to the prospective user and receive, via the user interface, the interview responses from the prospective user. The server application may also be configured to provide the interview responses to the artificial intelligence system. The server application may also be configured to transmit, via the user interface, the product recommendation of the one or more smart home products to the prospective user.

Optionally, the server application is further configured to retrieve data about a neighborhood in which the prospective user lives and provide the data about the neighborhood in which the prospective user lives to the artificial intelligence system. Optionally, the response parameters further include the data about the neighborhood in which the prospective user lives.

Optionally, one of the interview questions requests at least one image of the prospective user's home. The server application may further be configured to analyze the image to extract physical information about the home and provide the physical information about the home to the artificial intelligence system. Optionally, the response parameters further include the physical information about the home.

Optionally, one of the interview questions requests demographic information from the prospective user. Optionally, the choice data of existing users includes smart home devices used in the existing user's home and/or smart home services used in the existing user's home. Optionally, performance metrics associated with the choice data for existing users includes a usage metric associated with the choice data, a conversion metric associated with the choice data, a user satisfaction metric associated with the choice data, and/or a compliance metric associated with the choice data.

Optionally, the product recommendation further includes an installation plan for the recommended smart home products. Optionally, the product recommendation further includes a listing of the recommended smart home products including a natural language explanation of features and benefits specific to addressing an issue that triggered the recommendation. Optionally, the product recommendation further includes an installation location specific to the prospective user's home for each of the recommended smart home products. Optionally, the product recommendation further includes a configuration specific to the prospective user's home for each of the recommended smart home products.

Optionally, one of the recommended smart home products may be a smart home camera and the recommended configuration for the smart home camera may include a viewing angle for the smart home camera. Optionally, the product recommendation further includes an image of the prospective user's home including a depiction of an installation location for each of the one or more smart home products. Implementations of the described techniques may include hardware, a method or process, or computer software on a computer-accessible medium.

In some embodiments, the system may include one or more smart home devices; a user application executed by a user device, a server application, or any combination thereof. The server application can optionally be executed by a cloud based hosting system, a control unit of the smart home, or the user device. The user application can be configured to receive an assistance query from a user related their home (e.g., “How do I protect against the recent rash of break ins?” “Why is my office is cold even though my thermostat is turned up?” “I'm having a baby in May, do you have any suggestions” “I'm worried about my mom who has been falling down lately.”). In some embodiments, the user application may be configured to receive an indication of user behavior (e.g., the sound of a baby crying, the sound of a cough, or the like) instead or in addition to an assistance query. Whether triggered by the assistance query or the indication of user behavior, the user application can interact with the user based on interview questions provided by the server application to obtain additional information. The questions may be obtained by an artificial intelligence system of a server that fits the information from the assistance query and/or the user behavior to a model generated based on existing user characteristic data, choice data, and performance metrics associated with the choice data for that existing user. The user application can be configured to elicit responses from the user using the interview questions and provide them to the server application. As the server receives more information, correlated information can be identified and used with the assistance query and available information about the user to hone a recommendation and installation plan that will best suit the user's specific needs. For example, a reinforcement learning algorithm may be used based on the collected information to generate a recommendation based on mapping the collected information to the characteristic data for existing users in the database that stores the existing user characteristic data, choice data, and performance metrics associated with the choice data for that existing user. Once the collected information is mapped to characteristic data for existing users, those existing users' choice data (e.g., purchased smart home devices and services) may be used to make up the recommendation based on the performance metrics associated with the choice data. The server application can create the recommendation and installation plan that can include at least one recommended smart home device and, optionally, an installation plan for each recommended smart home device and provide it to the user application. The user application may then provide the recommendation and installation plan to the user. Other embodiments of this aspect include corresponding computer systems, apparatus, and computer programs recorded on one or more computer storage devices, each configured to perform the actions of the methods.

Implementations may also include one or more of the following features. Optionally, the server application can also be configured to extract demographic information from the user's responses to the questions. The server application can use the extracted demographic information to identify correlated information. For example, the extracted demographic information can be used to identify demographic groups of the user (e.g., groups of people of a similar age, similar income, similar family makeup, in the user's physical neighborhood, and so forth. Optionally, the server application can extract purchasing history patterns of the demographic group. Optionally, the server application can take into account the purchasing history patterns of the demographic group when generating the recommendation and installation plan. Optionally, the server application can use the purchasing history patterns of the demographic group and the purchasing history of the user to identify the user's purchasing power (e.g., available income and willingness to spend it on the recommendations). Optionally, the server application can take into account the user's purchasing power when creating the recommendation and installation.

Optionally, the server application can obtain at least one image of the home and analyze it to extract physical information about the user's home. The server application can use the extracted physical information about the user's home when creating the recommendation and installation plan. Optionally, the server application can analyze the image to identify behaviors of occupants of the home and use that information when creating additional questions to ask the user.

Optionally, the recommendation and installation plan can include a listing of the recommended smart home devices including a natural language explanation of the features and benefits specific to addressing the user's problem or original question. Optionally, the recommendation and installation plan can include an installation location specific to the home for each of the recommended smart home devices. Optionally, the recommendation and installation plan can also include configuration settings specific to the home for each of the recommended smart home devices. For example, the installation plan can include an installation angle of a smart home camera. Optionally, the recommendation and installation plan for the recommended smart home devices can include an image of the home showing the installation location for each of the recommended smart home devices.

Optionally, the user application can allow the user to adjust the recommendation and installation plan (e.g., remove a device, add a device, change a location of a device), and the server application can generate an updated recommendation and installation plan incorporating the user adjustment (e.g., reconfiguring location and configuration settings for all recommended devices in the recommendation).

Optionally, the server application can receive images of the home subsequent to the user installing the recommended smart home devices (e.g., the user can upload images, installed cameras can provide feedback, and so forth). The server application can analyze the image as compared to the recommendation and installation plan. Based on the analysis, when the image complies with the recommendation and installation plan (e.g., the devices are installed in the correct locations with the correct configurations) the server application can generate a notification to the user that the installation was correctly completed. When the image does not comply with the recommendation and installation plan, based on the analysis, the server application can generate a notification to the user including information on how to correct the installation to comply with the installation plan. Implementations of the described techniques may include hardware, a method or process, or computer software on a computer-accessible medium.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a block diagram of an embodiment of a system for intelligent identification and provisioning of devices and services for the smart home.

FIG. 2 illustrates a block diagram of an embodiment of an intelligent identification system.

FIG. 3 illustrates an embodiment of a portion of a recommendation and installation plan.

FIG. 4 illustrates an embodiment of a smart home environment for which the intelligent identification system can be used to implement.

FIG. 5 illustrates an embodiment of a method for intelligent identification and provisioning of devices and services for the smart home.

FIG. 6 illustrates an embodiment of an interface on an end user device for interfacing with the intelligent identification system.

FIGS. 7-12 illustrate machine-learned system configurations and workflows according to some embodiments.

### DETAILED DESCRIPTION

Smart homes are becoming ubiquitous. Devices from smart indoor and outdoor cameras to smart thermostats and smart hazard detectors link components of a home together to provide unparalleled efficiency, security, and convenience. However, some users may not know where to begin to turn their homes into a smart home environment. Other users have smart devices that may not be installed or configured to provide optimal efficiency, safety, or convenience. To address these issues, described herein is an intelligent identification system that a user can ask for help through a user interface of, for example, an application on the user's smartphone. The system can interact with the user by asking questions generated based on the user's initial request, information about the user, and the user's answers to pinpoint services and devices that can provide a solution for the user. The system can provide a recommendation to the user for the services and devices as well as, optionally, an installation plan to implement the solution.

Embodiments include a user interface through which the user can interact with the intelligent identification system. The user can use the user interface to create an assistance query. The assistance query can be a request by a user for identification of services and/or devices to be implemented in a smart home environment. The assistance query can be in the form of any request for help or any request for suggestions to improve a smart home environment. In some embodiments, the user interface may receive an indication of user behavior (e.g., the sound of a baby crying, the sound of a cough, the weight of a user from a smart scale indicating weight gain, and so forth. Whether an indication of user behavior or a direct assistance query, the intelligent identification system can analyze the information as described herein. Either the behavior information or an assistance query can be a triggering event that prompts the intelligent identification system to generate a recommendation as described herein. The intelligent identification system can analyze the assistance query and can generate interview questions designed to elicit additional information from the user. In some embodiments, the interview questions may be obtained using supervised machine learning. The intelligent identification system can use the additional information directly or to generate correlated (e.g., inferred) information relevant to the user. The intelligent information system can use the additional information and any correlated information to generate a recommendation for one or more smart home products (e.g., smart home devices and/or smart home services) responsive to the assistance query or indication of user behavior generated specifically for that user. For example, the recommendation can take into account the physical characteristics of the user's home, including its size, location, number of rooms, number of floors, number of windows, number of doors, type of structure, and so forth. The recommendation can also take into account that specific user's personal (e.g., demographic) information, such as number of children, number of pets, age, gender, marital status, number of occupants of the home, employment status, income, and so forth. The recommendation can further take into account that specific user's past purchase history and spending habits. Further, the recommendation can take into account purchase history and trends of similarly situated people, such as neighbors, other members of the user's income bracket, other members of the user's age group, and so forth. The recommendation can further take into account exterior factors for that specific user, such as crime rate of the location of the home, weather trends for the location of the home, and so forth. The recommendation may also take into account other characteristics specific to the user including an occupancy percentage of the user's home, health information known about the user, and so forth. In some embodiments, the recommendation is generated using a reinforcement learning algorithm.

Embodiments include advanced intelligence algorithms to generate the questions designed to elicit the additional information used in the interaction with the user. The advanced intelligence algorithms can learn from human agents as well as repeated interactions to generate effective questions designed to elicit the additional information that is useful for creating an effective recommendation specific to the user. For example, the intelligent identification system can request answers to specific questions (e.g., how many stories is your home?) or request images of the home (e.g., can you provide pictures of the exterior perimeter of your home?). The responses and images can be analyzed to extract information about the user and the user's home. The advanced intelligence algorithms can learn which questions will most quickly elicit the additional information that is most useful for generating the recommendation.

Embodiments include advanced intelligence algorithms to generate the recommendation and the installation plan. Once the interaction with the user produces additional information and correlated information, that information can be used to generate a recommendation for the client. For example, the purchasing power of the user in conjunction with the past purchase history of the user and purchase history patterns of other users that are in the same demographic group of the user can be used to generate a recommendation for services and devices that will likely fall within the user's budget and that is consistent with the user's existing devices (e.g., not recommending a smart thermostat if the user already owns one, recommending a solution of smart devices with a total cost of $500 for a user with a purchasing power of $450-$600 rather than a solution with a total cost of $1000). Additionally, the physical characteristics of the user's home can be used to generate a recommendation appropriate for the user's home (e.g., window open/close/motion/breakage sensors for ground level windows but not second story windows, 4 exterior cameras for a 1200 square foot home but 6 sensors for a 2500 square foot home). Further, the advanced intelligence algorithms can develop a natural language explanation of the features and benefits of each of the recommended devices and services and how they are relevant to the user's specific assistance query. The recommendation for smart devices and services can include an installation plan that can specify the recommended installation location for each of the recommended smart devices. The installation plan can also include configuration settings for each of the recommended smart devices. For example, the installation plan can provide a recommended viewing angle for a recommended smart home camera.

Embodiments include an installation compliance analyzer for analyzing the installation to ensure it complies with the recommendation and installation plan. The intelligent identification system can use information provided after installation of the smart devices to compare the installation with the recommendation and installation plan to determine whether the correct smart devices were installed in the recommended locations with the recommended configurations. For example, the installation compliance analyzer can receive information from the installed smart devices after installation to analyze and compare to the recommendation and installation plan. As another example, the user can upload images of the home with the installed smart devices. The system can analyze the images to determine whether the installed smart devices are located in the recommended locations. In some embodiments, the compliance analyzer can associate the compliance information as a compliance metric to the user's information in a database used to generate future recommendations for user. In that way, the reinforcement learning algorithm may use the compliance metric to improve future recommendations.

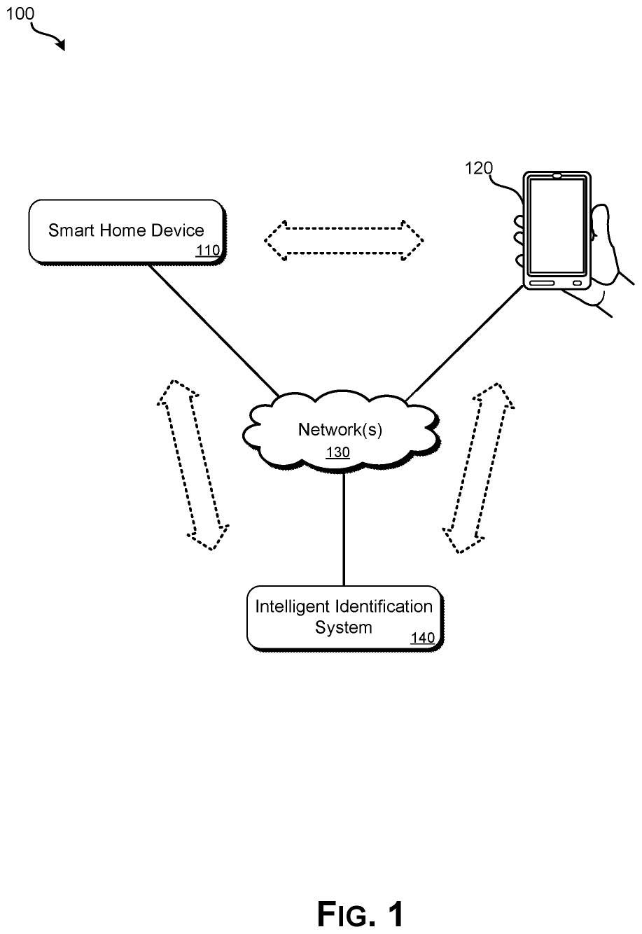

FIG. 1 illustrates a block diagram of an embodiment of a system 100 for intelligent identification and provisioning of devices and services for the smart home. System 100 can include smart home device 110, one or more networks 130, intelligent identification system 140, and user device 120. System 100 can include any number of smart home devices, though only one is shown for simplicity. Throughout this disclosure, device recommendations can include recommendations for services as well. For example, smart cameras may utilize a cloud storage service that can be utilized. As described herein, recommendations for services can be included in any description of recommendations for devices, and a recommendation for a service need not be accompanied by a recommendation for a device.

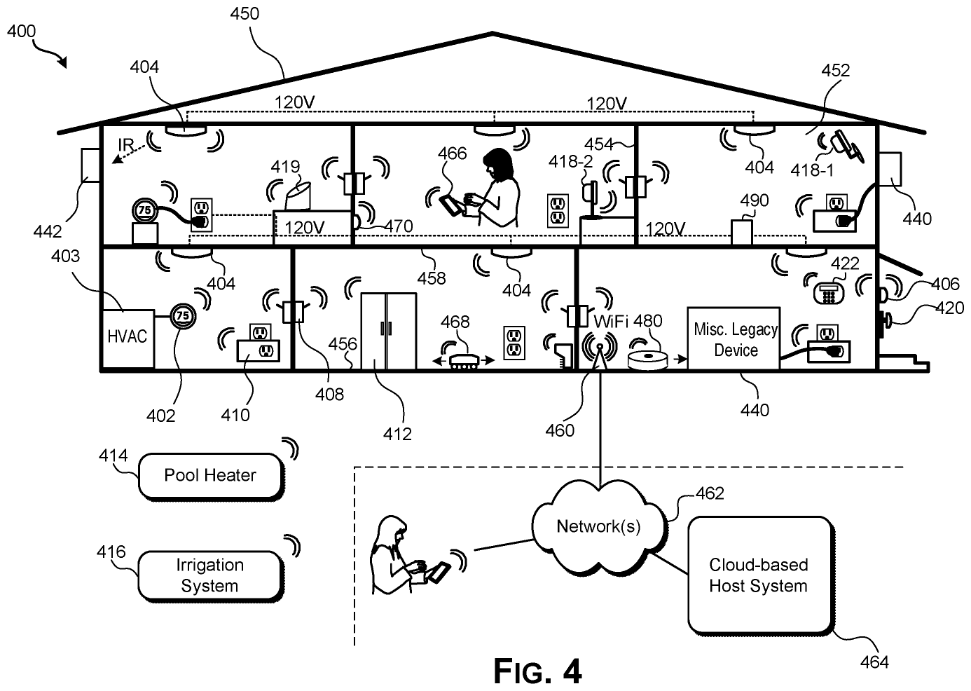

Smart home device 110 can represent a smart device that is installed and located at a user's home. Various forms of smart home devices are detailed in relation to FIG. 4. Smart home device 110 can communicate through network(s) 130 with user device 120 and/or intelligent identification system 140. Smart home device 110 can be installed at a user's home and can provide various functionality. Smart home device 110 can provide information about the user's home. For example, smart home device 110 can provide video stream or imaging information, temperature information, security information, presence information, and so forth. Optionally, the user may not have a smart home device 110 prior to utilizing the intelligent identification system 100.

Networks 130 may include a local wireless area network and the Internet. In some embodiments, smart home device 110 can communicate using wired communication to a gateway device that, in turn, communicates with the Internet.

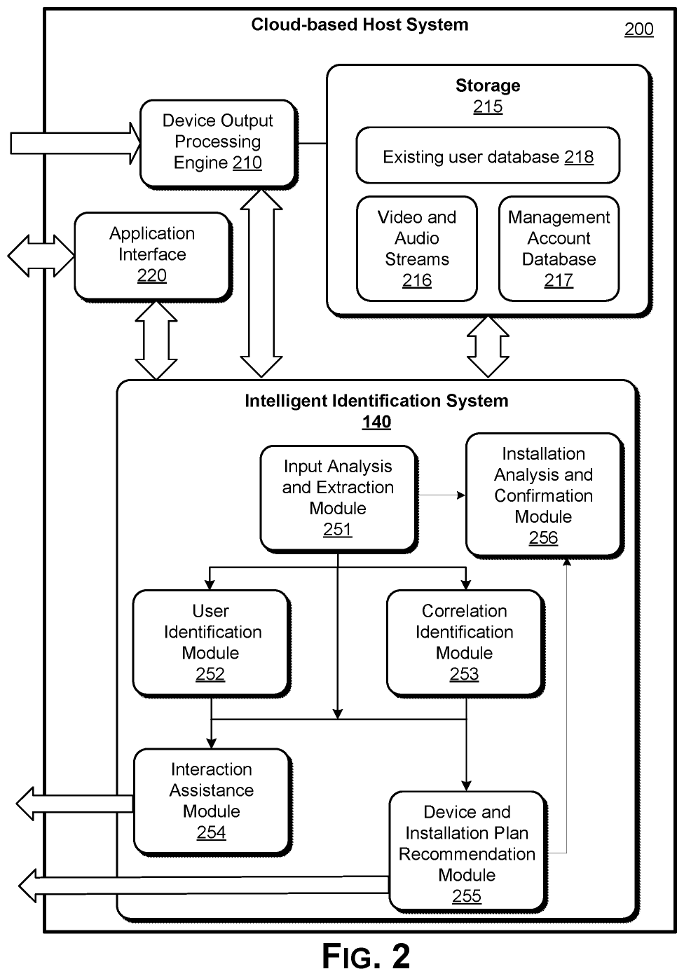

Intelligent identification system 140 may communicate with smart home device 110 and/or user device 120 via one or more networks 130, which can include the Internet. Intelligent identification system 140 may include one or more computer systems. Further detail regarding intelligent identification system 140 is provided in relation to FIG. 2. In some embodiments, rather than intelligent identification system 140 being incorporated as part of one or more cloud-accessible computing systems, Intelligent identification system 140 may be incorporated as part of smart home device 110, a smart home controller (not shown), or user device 120. As such, one or more processors incorporated as part of smart home device 110, and/or user device 120 can perform some or all of the tasks discussed in relation to intelligent identification system 140 detailed in relation to FIG. 2.

User device 120 may be used to provide a user application including a user interface to interact with the user for providing the intelligent identification functionality. User device 120 can be any suitable device capable of providing the user application and communicating over network 130 with smart home device 110 and intelligent identification system 140. User device 120 can be a computerized device such as, for example, a smart phone, a tablet, a laptop computer, a desktop computer, a smart watch, or the like. The user application may be a native application that is downloaded, installed, and executed on end-user device 120. In other embodiments, functionality of the user application may be provided in the form of a webpage that is accessed using a browser executed by end-user device 120. The user can query the intelligent identification system and provide information through the user interface. User device 120 and smart home device 110 may each be registered with a single management account maintained by intelligent identification system 140. Having each device registered with a same management account can allow the intelligent identification system 140 to correlate information specific to the user's home with the end-user, which can be used for providing the recommendation and installation plan.

In use, a user can interact with the user application (via the user interface) on user device 120. The user can provide an assistance query. In some embodiments, the smart home device 110 may be used to provide the assistance query and/or may automatically collect behavior information for the user that triggers a recommendation to be generated as described herein. While described throughout as an assistance query, behavior information can be used interchangeably. The assistance query can be a request by a user for identification of services and/or devices to be implemented in a smart home environment. The assistance query can be in the form of any request for help, any request for suggestions to improve a smart home environment, or any activity that suggests the user may be receptive to a recommendation. The user device 120 can provide the user assistance query and other inputs into the user application to the intelligent identification system 140 for generating a recommendation and installation plan for the user regarding the user's assistance query. The intelligent identification system 140 can provide questions and information to the user device 120 for interacting with the user. As the user responds to the questions, the responses are sent to the intelligent identification system 140 via network 130. The smart home device 110 can also be utilized by the intelligent identification system 140 for gathering information about the user's home. For example, if the smart home device 110 is a camera, a video stream from the smart home device 110 can be analyzed by the intelligent identification system 140 and information can be extracted and used for generating the recommendation and installation plan. Once the intelligent identification system 140 generates the recommendation and installation plan, it can be provided to the user device 120 for providing to the user through, for example, the user interface.

FIG. 2 illustrates a block diagram of a cloud-based host system 200 hosting the intelligent identification system 140. Intelligent identification system 140 may be performed by cloud-based host system 200, possibly in addition to other functions. While described here as cloud-based, cloud-based host system 200 may be any server system capable of performing the functionality described herein. Cloud based host system 200 may include intelligent identification system 140, device output processing engine 210, application interface 200, and storage 215. Additionally, cloud-based host system 200 may include more or fewer components.

A function of cloud-based host system 200 may be to receive and store video and/or audio streams from a smart home device, such as smart home device 110. Device output processing engine 210 may receive information output by smart home devices including video and audio streams from streaming video cameras, temperature readings and settings from thermostats, and so forth. Received video and audio streams may be stored to storage 215 for at least a period of time. Storage 215 can represent one or more non-transitory processor-readable mediums, such as hard drives, solid-state drives, or memory. Device output processing engine 210 may route video to intelligent identification system 140 if a management account linked to the received video is interfacing with the intelligent identification system 140.

Storage 215 may include video and audio streams 216, management account database 217, and existing user database 218. Storage 215 may include additional information not described herein in some embodiments. Video and audio streams 216 can represent various video and audio streams that are stored for at least a period of time by storage 215. Cloud-based host system 200 may store such video streams for a defined window of time, such as one week or one month. The video and audio streams 216 may include the video and/or audio streams received by device output processing engine 210.

Management account database 217 may store account information for many user accounts. Account information for a given management account can include a username, password, indications of various devices linked with the management account (e.g., smart home device 110). By logging in to a particular management account, a user may be able to access stored video and audio streams of video and audio streams 216 linked with that management account. By accessing a management account, the user may also be able to access information relating to any recommendation and installation plans generated by intelligent identification system 140.

Existing user database 218 may include data about existing users of smart home devices. The existing user database 218 may include characteristic information about existing users. Characteristic information may include, for example, demographic information about the user (e.g., name, age, residence address, occupation, marital status, number of children, number of pets, income information, and so forth), physical information about the user's residence (e.g., size of the house, number of stories, number of windows, whether it is in a cul-de-sac or on a busy street, and so forth), purchase history and spending habits of the user, and information about the user's residence location (e.g., crime statistics, median household income of the neighborhood, climate, and so forth). The existing user database 218 may also include choice data for the existing users including, for example, their existing smart home devices and services. The existing user database 218 may further include performance metrics associated with each choice data for each existing user. For example, an existing user that owns a smart home camera, but never accesses the stored camera footage, may have a poor performance metric value based on this usage metric for this choice data (i.e., the smart home camera). As another example, a user may have recommended their smart home thermostat to several other users and therefore has a positive performance metric value based on this recommendation metric for this choice data (i.e., the smart home thermostat). As yet another example, a user may rate their smart home occupancy sensor poorly (e.g., a low star rating of only one or two stars or a thumbs down) and have a poor performance metric value for this choice data (i.e., the smart home occupancy sensor). As yet one further example, a user may have a 7-day free trial for a sleep monitoring subscription service feature of their smart home camera. When the user converts to a paid subscription, the performance metric value based on this conversion metric may be high for this choice data (i.e., the sleep monitoring subscription service).

Device output processing engine 210 may perform various processing functions on received device output and video streams. If a particular video stream is to be analyzed to generate a recommendation and installation plan, device output processing engine 210 may route a subset or all video frames to intelligent identification system 140. If a user has requested help or presented an assistance query to a smart home device, device output processing engine 210 may route the information to intelligent identification system 140.

Application interface 220 can interface the intelligent identification system 140 with an application on a user device for obtaining information from the user and providing a recommendation and installation plan. Optionally, the application interface 220 can interface with any suitable application, including a web page/web application. Examples of user applications that can include an interface to application interface 220 for interacting with intelligent identification system 140 can include a dedicated application on a user device, a web page/web application, a user support application, a sales support application, a third party application, or any other suitable application.

Intelligent identification system 140 can include an input analysis and extraction module 251, a user identification module 252, a correlation identification module 253, an interaction assistance module 254, a device and installation plan recommendation module 255, and an installation analysis and confirmation module 256. While depicted as specific modules within intelligent identification system 140, the functionality described can be performed by more or fewer modules without departing from the scope of the disclosure.

Input analysis and extraction module 251 can obtain incoming information regarding the user's assistance query or behavior information during a user session with the intelligent identification system 140. Input analysis and extraction module 251 can analyze the incoming information and parse out information for further use. For example, the input analysis and extraction module 251 can analyze textual input to parse natural language entries for further processing. As another example, the input analysis and extraction module 251 can analyze images to extract information for further processing. As yet another example, the input analysis and extraction module 251 can analyze audio input by, for example, converting speech to text and then analyzing the text. Input analysis and extraction module 251 may also analyze behavior information of the user to identify the relevant information such as, for example, identifying a cough or that a user is not sleeping well. The input analysis and extraction module 251 may analyze the assistance query or behavior information to identify an issue that triggers the generation of the recommendation as described herein. The identified issue and other information obtained by the input analysis and extraction module 251 from the behavior information or assistance query can be sent as initial input parameters to the interaction assistance module 254 and/or the user identification module 252.

Textual input can be analyzed to identify the user name, the assistance query, and any other provided information. For example, upon first contact, the user may provide an assistance query. Such queries can also be referred to as problem statements and can include any problem or question the user may have. For example, the user can type or ask “How do I protect against the recent rash of break ins?” or “Why is my office is cold even though my thermostat is turned up?” or “I'm having a baby in May, do you have any suggestions” or “I'm worried about my mom who has been falling down lately”. Optionally, users can provide information in any form, so it is unstructured. The input analysis and extraction module 251 can analyze the text to identify the assistance query. Initial contact can optionally include a user name. Optionally, future responses can include a user name or other identifying information, such as a username. The input analysis and extraction module 251 can analyze all incoming input similarly to identify key words and/or extract identifying information or answers to requests that provide helpful information. For example, demographic information can be extracted including age, number of household occupants, income, location, neighborhood, gender, marital status, and so forth.

Video or image input can be analyzed to identify information regarding the user home. Optionally, the user can upload images or video of their home for analysis. The input analysis and extraction module 251 can use image analysis techniques to identify information about the home including, for example, physical information about the home such as number of windows, location, number of rooms, and so forth. Optionally, image analysis can identify demographic information including number of occupants, age of occupants, and so forth. For example, vector analysis can be used to identify humans, color, tone, and shape distinctions can be used to identify objects (e.g., a bright square indicates a window), and so forth. Analysis to identify humans can further identify approximate age. Using such techniques, information can be inferred including, for example, number of occupants and relationships (e.g., parent, child, spouse, roommate) based on identified humans and ages. Image analysis of objects can, for example, provide sufficient information to infer a size of the home, the number of rooms, the number of windows, the location of windows and doors, and so forth. Further, image analysis can be used to identify behaviors of the occupants of the house. For example, areas not heavily used can be inferred based on images of rooms that are empty or sparsely furnished. As another example, a rocking chair near a crib can indicate that a parent rocks their child to sleep. As yet another example, safety rails in a bathroom can indicate an elderly or disabled person uses that particular bathroom. This type of behavioral information can be useful to identify recommended locations for smart devices. For example, smart devices that are located in low traffic areas will not accurately identify when occupants are present with presence detection because the occupants will rarely be near enough the smart device to trigger the presence detection. As another example, the parent that rocks the child to sleep may prefer an automatic window opening and closing device to control the window while rocking the baby without having to get up and wake the baby. As another example, safety rails in a particular bathroom, indicating a disabled or elderly occupant may use that bathroom, may warrant a recommendation of a smart camera with a view of the bathroom door so that a caretaker can utilize the smart camera feed to or recording to identify whether the occupant may need help in the bathroom if in there too long.

User identification module 252 can use information provided from the input analysis and extraction module to identify the user and/or information about the specific user. Optionally, the user is new and does not yet have a profile. Optionally, the user has items in an electronic shopping cart in the user application that can be identified by user identification module 252. In some embodiments, the user has logged into an application to access the intelligent identification system 140, so a username of the user is known. In some embodiments, the user can provide a name, user number, order number, or other information that can be used to identify the user. User identification module 252 can use the available information, such as name, location, username, and so forth to identify a single user. If a user can be identified, the purchase history of the user can be obtained from, for example, a sales system database or a user relationship database (not shown). Any other available information about the user can also be obtained including age, gender, marital status, income, address, smart home device use history, family status (e.g., ages of children, whether children live with user, whether parents live with user), work status (e.g., employed, work from home, stay at home parent), and so forth. The user identification module 252 may identify the user in both the management account database 217 and/or the existing user database 218 to obtain further information about the user.

Correlation identification module 253 can use information provided from the input analysis and extraction module to identify correlated information. For example, correlation identification module 253 can identify information related to the user's location, demographic profile, and so forth. Correlation identification module 253 can obtain the location of the home and demographic information from input analysis and extraction module 251. Correlation information related to the user's location can include, for example, information about the user's neighborhood or area including median household income, crime statistics for the area, recent crimes in the vicinity, weather and climate information, and air quality information and can be obtained from, for example, online sources. Correlation identification module 253 can also identify demographic groups that the user belongs to. For example, demographic information can include age, income, disability, family status, marital status, gender, employment status, and address/neighborhood. Any demographic information provided by input analysis and extraction module 251 can be used to identify a demographic group using one or more pieces of demographic information (e.g., women, married women, single mothers, middle-aged working mothers, and so forth). Once a demographic group is identified, correlation identification module 253 can identify information about the demographic group including, for example, purchase history patterns and/or purchasing trends of the demographic group. Correlation identification module 253 can further use, for example, purchasing trends of the demographic group in conjunction with the user's purchasing history and other information such as income to estimate the user's purchasing power. The user's purchasing power can be, for example, an estimation of the amount of money the user is likely to be willing to spend on the recommendation provided by the intelligent identification system 140.

The interaction assistance module 254 can use the information extracted from the input analysis and extraction module 251, the user identification module 252, and the correlation identification module 253 to generate additional questions or requests to ask of the user during the user interaction via the user application. For example, the initial question or assistance query can ask about security, and the interaction assistance module 254 can request that the user take images of the exterior of the home and images of the interior perimeter. Upon identifying a fence in one image of the rear of the house, the interaction assistance module 254 may generate a question such as, for example, “It looks like your back yard is fenced in, is there a lock on the gate?” The interaction assistance module 254 can be configured to generate natural language questions, leaving the user feeling that he or she is conversing with a human. Optionally, the interaction assistance module 254 can generate many questions to confirm the inferred information from image analysis or correlation identification module 253. Optionally, the interaction assistance module 254 can generate just a few simple questions to pinpoint a solution. For example, the interaction assistance module 254 can ask for images, the square footage of the house, and the number of stories. Advanced intelligence algorithms can be used to learn from human agents and repetitive interactions with users to develop optimized interactions for providing targeted recommendations. For example, interaction assistance module 254 may include a supervised learning algorithm that generates models based on the characteristic data, choice data, and performance metrics associated with the choice data for existing users in the existing user database 218. In some embodiments, the supervised learning algorithm generates initial models and updates the models periodically. In some embodiments, the supervised learning algorithm generates models upon the triggering of a recommendation based on an assistance query and/or behavior information that indicates an issue. The information known by the interaction assistance module 254, including the input parameter information obtained from the assistance query or behavior information that triggered intelligent identification system 140 to generate a recommendation for the user, may be fitted to a model generated by the supervised learning algorithm. The models may include information about the existing users as well as interview questions that may be used to elicit additional information from the user that may be used to generate the best possible recommendation for the user to address the issue identified in the assistance query or behavior information. The interview questions extracted from the fitted model may be provided to the user application or user interface to elicit the additional information. Further, the interaction assistance module 254 may adjust the interview questions to, for example, remove those to which the intelligent identification system 140 already knows the answer.

The device and installation plan recommendation module 255 can use the information extracted from the input analysis and extraction module 251 (e.g., the initial input parameters identified from the assistance query or behavior information and any additional information extracted from the interview responses), the user identification module 252 (e.g. user specific demographic information, current electronic shopping cart contents, and so forth), and the correlation identification module 253 (e.g., inferred user specific information based on image analysis, information related to the user's location, demographic group information, and so forth) to generate a recommendation of smart home devices and, optionally, an installation plan (the recommendation and installation plan). The recommendation can include one or more smart home devices and/or services. The recommendation and installation plan can include a specific installation plan for each of the recommended smart home devices. The device and installation plan recommendation module 255 can use advanced intelligence algorithms such as a reinforcement learning algorithm to identify matching characteristic data of existing users in the existing user database 218. Using the choice data and associated performance metrics of the matching existing users, the reinforcement learning algorithm may generate the recommendation. The recommendation may be based on characteristic data including purchasing power, the assistance query or behavior information (e.g., the identified issue), demographic group purchasing history, other demographic information, physical characteristics of the user's home, and so forth. The performance metrics associated with the choice data (e.g., the existing user's devices or services), may be used to generate a weighted recommendation of each recommended product. In some embodiments, the recommendation may include a weighted score for each recommended product and/or provide the listing of recommended products in order from those with the highest weighted score to the lowest weighted score.

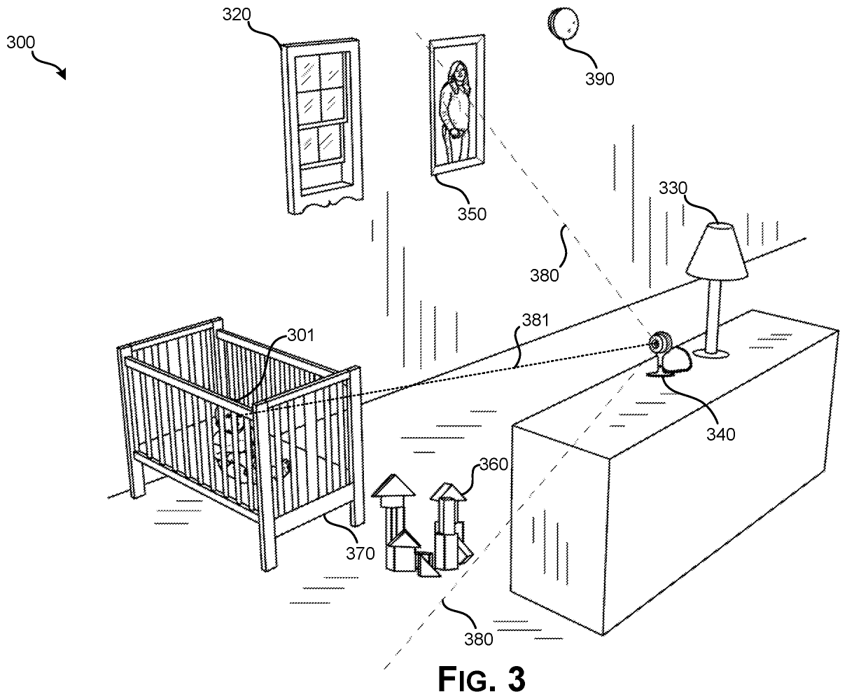

The device and installation plan recommendation module 255 may generate the installation plan based on the identified issue and other initial input parameters (e.g., assistance query or behavior information), user specific information, the specific information about the home, and the recommended devices. The device and installation plan recommendation module 255 can include a location for each recommended smart device and, optionally, device configurations. The installation plan can provide recommended configuration settings such as, for example, a smart thermostat schedule, an angle of installation and/or viewing angles for cameras, and so forth. Optionally, the device and installation plan recommendation module 255 can provide a list of each recommended smart device (and/or service) with a natural language explanation of the features and benefits of the recommended device as it pertains to the user's specific home, information, and assistance query. For example, if the user's assistance query is regarding security, the front of the user's home is near an alley, and the recommendation includes a smart camera on the front of the user's home with a view of the alley, a natural language explanation of the smart camera can specifically mention the alley. The natural language explanation of the recommended smart camera and its recommended installation plan can state, for example, “We recommend installing a smart camera above your garage door with a view of the alley across the street. There have been several recent break ins in your neighborhood and a police bulletin issued that noted several loitering tickets have issued recently to teens congregating in alleys. The smart camera can be configured to record only when sound and/or motion are detected, so you can capture and easily find activity without having to sift through non-stop recordings. The camera also includes infrared LEDs for night vision, which allows the camera to capture recordings when it is dark without lighting up the scene with a human-visible light. In the event you want to light the scene, the camera includes a floodlight that can be remotely controlled, and an alert option to alert you when the camera is triggered by motion or sound. So, if the teens happen to congregate in the alley across the street from you, the camera can record footage even at night, alert you to the activity, and you can choose to turn on the floodlight, which might just deter those teens from hanging around your home.” Optionally, the device and installation plan recommendation module 255 can include an image of the user's installation location for each recommended smart device depicting the installation location of the device and providing configuration information for the installation. For example, the recommendation and installation plan for the smart devices can include an image (e.g., a user uploaded image) of the user's home with the recommended smart devices superimposed on the image to visually depict for the user the locations in which to install each recommended smart device. FIG. 3 illustrates an example image portion of a recommendation and installation plan.

Optionally, once a recommendation is provided, the user can modify the recommendation and/or the installation plan if one was provided. For example, the user can remove devices from the recommendation, add devices to the recommendation, and/or change an installation location or configuration of devices. Upon receiving the modification, the device and installation plan recommendation module 255 can use the updated device list and/or locations and/or configurations to provide an adjusted recommendation and/or installation plan that is also (i.e., still) based on the information extracted from the input analysis and extraction module 251 (e.g., the assistance query), the user identification module 252 (e.g. user specific demographic information, current electronic shopping cart contents, and so forth), and the correlation identification module 253 (e.g., inferred user specific information based on image analysis, information related to the user's location, demographic group information, and so forth). For example, if a user adjusts an angle of a camera, another camera can be added to the recommendations to provide a view of the area that is no longer in view of the adjusted camera. As another example, another recommended camera can be relocated and shifted to help provide a view of at least a portion of the area that is no longer in view of the adjusted camera. As yet another example, if a user adds a device other device locations and configurations can be adjusted. In some embodiments, the user modifications and modified recommendation may be used by the reinforcement learning algorithm in the device and installation plan recommendation module 255 to learn from the modification and improve future recommendations and store the information, including the recommendations as choice data and use the modification to generate a performance metric indicating the dissatisfaction of the user to the original recommendation.

The installation analysis and confirmation module 256 can receive the recommendation and installation plan from the device and installation plan recommendation module 255 and information about the installation from the input analysis and extraction module 251. For example, the user can upload an image of the installed devices via the user application to the intelligent identification system 140. Optionally, installed devices can provide information to the intelligent identification system 140. For example, once a device is installed, configuration options may include identifying a room or location it is installed in, which can be transmitted by the smart home device to the intelligent identification system 140. As another example, a smart camera can provide an image of its viewing angle to the intelligent identification system 140. Upon receiving the recommendation and the information regarding the installed devices, the installation analysis and confirmation module 256 can analyze the information and compare the analysis against the recommendation and installation plan. For example, a recommendation can include a smart thermostat and the installation plan can recommend installation in a hallway between the living room and the powder room because analysis indicates that the hallway is a high-traffic area, such that a presence detection sensor in the thermostat would be most likely to get presence detection if occupants are home. If the information regarding the installation indicates that the thermostat was installed in a guest room, the installation analysis and confirmation module 256 can identify non-compliance with the installation plan. In such instances, the installation analysis and confirmation module 256 can generate a notification to the user that alerts the user to the non-compliance. Continuing the example, the notification can state, for example, “The thermostat has been installed in the guest room, but the installation plan recommended installing the thermostat in the hallway for the best efficiency. You may want to consider moving the thermostat to the hallway to keep your energy bills lower.” If the installation analysis indicates that the installation complies with the installation plan, the installation analysis and confirmation module 256 can notify the user that the installation complies by, for example, providing a notification stating “The installation of your smart home devices looks great. Feel free to check back in with us if you have any problems or questions.” In some embodiments, the compliance or refusal to comply with the recommendation may be captured as a performance metric for the user's information in the existing user database and associated with the choice data (the recommended devices and services). The feedback of this information into the existing user database 218 may enhance the reinforcement learning algorithm's ability to generate the best recommendation for the users. Throughout this application, the words “notify,” “ask,” “state,” and the like are used to describe providing information or obtaining information from a user. In some embodiments, a graphical (e.g., visual) user interface may be used to interact (e.g., “notify,” “ask,” “state,” and the like) with a user. In some embodiments, an audible, voice-based interface may be used to interact with a user. For example, a GOOGLE® Home device or the like may be used to interact with the user. An audible voice-based interface may be preferable in some embodiments because it may be an easier interface and/or the user may be more comfortable with the audible, voice-based interface. However, when desirable (e.g., for a user to be more comfortable), a graphical user interface may be used.

FIG. 3 illustrates an example of an image portion 300 of a recommendation and installation plan. The recommendation and installation plan can include a listing of recommended smart devices, and the image portion 300 of the recommendation and installation plan can provide a visual illustration to the user of the devices and where to locate and position the recommended smart devices. FIG. 3 can be used to provide an illustrative use case. To get the image portion 300, the user can begin with an assistance query of, for example, “I had a baby last month, and I want to ensure the nursery is safe for her.” The user can present the assistance query, for example, through a dedicated application on their smart phone that provides a user interface. The user interface can facilitate the interaction through, for example, a text chat format or an audio conversation format. The intelligent identification system 140 can receive the assistance query, and the input analysis and extraction module 251 can use keyword analysis to target the words “baby,” “nursery,” and “safe.” Because, for example, the user is logged in to the user application, the user is known, and the user's username is provided with the assistance query to the intelligent identification system 140. The input analysis and extraction module 251 can provide the username to the user identification module 252. The user identification module 252 can query, for example, the management account database 217 to obtain the user's name (e.g., Jane Doe), the user's purchase history (e.g., a smart thermostat and a smart camera), the user's existing system configuration (e.g., the smart thermostat is installed in the living room and the smart camera is installed on the exterior of the home with a view of the front door), the user's location (e.g., address in Miami, Fla.), and so forth. Given the known information, the correlation identification module 253 can generate correlated information such as, for example, an estimated purchasing power based on the user's address and past purchasing history (e.g., purchasing power is approximately $300-$350 based on the address is a rental unit in a lower income area and the user has few (two) devices.) As another example, the correlation identification module 253 can identify purchase history patterns of members of the user's neighborhood (e.g., the most popular product in the neighborhood is a smart camera and the least popular product is an alarm system). The interaction assistance module 254 can use the supervised learning algorithm to fit the user specific data that was received to a model generated from the existing user database 218. The supervised learning algorithm can extract the interview questions from the model, and the interaction assistance module 254 can analyze the interview questions to remove any to which the answer is already known. The interview questions can then be used to interact with the user, such as the following interaction:

User: “I had a baby last month, and I want to ensure the nursery is safe for her.”

Intelligent Identification System: “I'd love to help you with that, Jane. Is the nursery on the first floor?”

User: “Yes.”

Intelligent Identification System: “Great, could you upload a picture of the nursery?”

The user can upload an image of the nursery similar to image portion 300. The user uploaded image may not include smart hazard detector 390 or smart camera 340. When the input analysis and extraction module 251 can analyze the image and identify the crib 370, the baby 301, the window 320, the picture 350, the toys 360, and the lamp 330. The input analysis and extraction module can provide the image information and the assistance query to the device and installation plan recommendation module 255. The user identification module 252 can provide the user's name, the user's location, the user's purchase history, and the user's existing system configuration to the device and installation plan recommendation module 255. The correlation identification module 253 can provide the correlated information including the purchase history patterns of members of the user's neighborhood and the purchasing power of the user.

The device and installation plan recommendation module 255 can analyze the information and use the reinforcement learning algorithm to map the information to characteristic data in the existing user database 218 to generate a recommendation and installation plan. For example, the device and installation plan recommendation module 255 can first determine based on the assistance query that the recommendation should focus on safety in the nursery. Based on the image data, the device and installation plan recommendation module 255 can determine that there is a potential safety issue with the window 320, and there is a potential safety issue regarding hazard detection because no hazard detection units are visible in the image. The device and installation plan recommendation module 255 can determine, based on the safety issues, and by mapping the information to characteristic data in the existing user database 218 that an initial recommendation can include an alarm system with a window open/close/motion/breakage sensor for the window 320 costing $499, a smart camera to provide a view of the baby 301 costing $199, a smart camera to provide a view of the window 320 costing $199, and a smart hazard detector costing $119. The device and installation plan recommendation module 255 can determine that the cost of the four devices is $1016. Each device may have a weighted score based on the performance metrics associated with the choice data of the associated characteristic data mapped to the information specific to the user.

The device and installation plan recommendation module 255 can further determine that the initial recommendation is too expensive for the user's purchasing power. To remove devices from the recommendation, the device and installation plan recommendation module 255 can use the weighted score to remove items until the recommendation is within a threshold value of the user's purchasing power. In some embodiments, using the supervised learning algorithm, the device and installation plan recommendation module 255 may determine that the window 320 can be monitored by either the security camera or the security alarm with the window open/close/motion/breakage sensor but both are not necessary. Based on the purchase history patterns of the neighborhood showing that the most popular product in the neighborhood is a smart camera and the least popular product is an alarm system, and based on the cost of the alarm system ($499), the device and installation plan recommendation module 255 can generate a second recommendation removing the alarm system, leaving the smart hazard detector ($119) and two smart cameras ($199 each). The device and installation plan recommendation module 255 can determine that the cost of the three devices is $517 and still too expensive.

The device installation and recommendation module 255 can further determine that a single camera can provide a view of both the window 320 and the crib 370, and can remove one of the two smart cameras, leaving a recommendation of a smart hazard detector and a smart camera, costing a total of $318. The device installation and recommendation module 255 can generate the image portion 300 of the recommendation and installation plan by using the image provided by the user and superimposing smart hazard detector 390 and smart camera 340 on the image in the recommended installation locations. The device installation and recommendation module 255 can recommend the locations based on the image analysis information. For example, the smart hazard detector 390 is recommended to be located a sufficient distance from the window to ensure that it properly detects hazards like smoke and carbon monoxide without being unduly affected by an open window 320. Further, the smart camera 340 can be located and positioned on the dresser to provide a view of the window 320 and the crib 370. The image portion 300 of the recommendation and installation plan can further include the viewing angle dotted line 380 and the direct line of sight line 381 to help the user visually understand the recommended location and positioning of the smart camera 340.

The recommendation and installation plan can further include a listing of the recommended devices providing a natural language explanation of the features and benefits of the recommended smart devices. For example, the listing can state the following information in connection with the recommended smart devices shown in image portion 300 of the recommendation and installation plan.

Smart Hazard Detector: We recommend you purchase and install a smart hazard detector in the nursery. The smart hazard detector detects smoke and carbon monoxide, which are both dangerous for your baby. The smart hazard detector has a great self-test feature, since most of us do not regularly test the batteries in our hazard detectors as we should, the smart hazard detector will self-test the batteries daily, and quietly self-test the speaker and horn monthly to ensure it is functioning properly so you don't have to concern yourself with that and can focus on your baby. The smart hazard detector has a path light feature that is perfect for your baby's nursery. If you need to check your baby at night, you will not have to turn the lights on and wake her! Rather, when it senses your movement, the smart hazard detector will provide a soft light that will not wake the baby. The smart hazard detector also features a remote hush feature that allows you to quiet the alarm if it triggers and you have everything under control, which can also protect from waking the baby.

Smart camera: We recommend you purchase and install a smart camera in the nursery adjusted to provide a view of the crib and the window. The smart camera will give you peace of mind when the baby is in the crib and you are not in the room. You can check the camera easily from your smart phone, so you can check her whether you're in the next room or not even home. Keeping the camera adjusted to provide a view of the window as well can provide benefits like being able to easily check if the window was left open without having to go in the room and potentially wake the baby. The smart camera also alerts you if it senses conspicuous sounds like a crash or a window breaking, so even if you're not watching the video feed, you'll be alerted and know if something happens.

Once the user has installed the recommended smart devices, the user can provide, for example, an image of the installation location of the installed smart devices. The installation analysis and confirmation module 256 can analyze the image and compare it with the recommendation and installation plan to ensure the installation complies with the recommendation. For example, image analysis can compare the image portion 300 with the uploaded image from the user after installation and confirm that the smart hazard device 390 is installed as indicated in image portion 300 and smart camera 340 is installed and adjusted to include the crib 370 and the window 320 in the viewing angle of the smart camera 340. If the camera is not installed or is pointing in a wrong direction or at an incorrect angle (e.g., the crib is in the camera view but the window is not), the installation analysis and confirmation module 256 can notify the user with, for example, “The crib is in view of the camera, but the window is not. Having the window in view of the camera can be helpful because you'll know, for example, if the window was left open at night without waking the baby to check. You can fix this by turning the camera 45° to the left (¼ turn towards the window).” In some embodiments, the compliance information can be used to generate a compliance metric stored as a performance metric in the existing user database 218 and used to enhance the reinforcement learning algorithm future recommendations.

FIG. 4 illustrates an embodiment of a smart home environment for which the intelligent identification system can be used to implement. A streaming video camera may be incorporated as part of a smart home environment. Additionally or alternatively, a streaming video camera may be incorporated as part of some other smart home device, such as those detailed in relation to smart home environment 400.

The smart home environment 400 includes a structure 450 (e.g., a house, office building, garage, or mobile home) with various integrated devices. It will be appreciated that devices may also be integrated into a smart home environment 400 that does not include an entire structure 450, such as an apartment, condominium, or office space. Further, the smart home environment 400 may control and/or be coupled to devices outside of the actual structure 450. Indeed, several devices in the smart home environment 400 need not be physically within the structure 450. For example, a device controlling a pool heater 414 or irrigation system 416 may be located outside of the structure 450.

It is to be appreciated that “smart home environments” may refer to smart environments for homes such as a single-family house, but the scope of the present teachings is not so limited. The present teachings are also applicable, without limitation, to duplexes, townhomes, multi-unit apartment buildings, hotels, retail stores, office buildings, industrial buildings, and more generally any living space or work space.

It is also to be appreciated that while the terms user, user, installer, homeowner, occupant, guest, tenant, landlord, repair person, and the like may be used to refer to the person or persons acting in the context of some particular situations described herein, these references do not limit the scope of the present teachings with respect to the person or persons who are performing such actions. Thus, for example, the terms user, user, purchaser, installer, subscriber, and homeowner may often refer to the same person in the case of a single-family residential dwelling, because the head of the household is often the person who makes the purchasing decision, buys the unit, and installs and configures the unit, and is also one of the users of the unit. However, in other scenarios, such as a landlord-tenant environment, the user may be the landlord with respect to purchasing the unit, the installer may be a local apartment supervisor, a first user may be the tenant, and a second user may again be the landlord with respect to remote control functionality. Importantly, while the identity of the person performing the action may be germane to a particular advantage provided by one or more of the implementations, such identity should not be construed in the descriptions that follow as necessarily limiting the scope of the present teachings to those particular individuals having those particular identities.

The depicted structure 450 includes a plurality of rooms 452, separated at least partly from each other via walls 454. The walls 454 may include interior walls or exterior walls. Each room may further include a floor 456 and a ceiling 458. Devices may be mounted on, integrated with and/or supported by a wall 454, floor 456 or ceiling 458. Some devices may not be mounted and instead are merely placed on a table, dresser, floor, or the like.

In some implementations, the integrated devices of the smart home environment 400 include intelligent, multi-sensing, network-connected devices that integrate seamlessly with each other in a smart home network and/or with a central server or a cloud-computing system to provide a variety of useful smart home functions. The smart home environment 400 may include one or more intelligent, multi-sensing, network-connected thermostats 402 (hereinafter referred to as “smart thermostats 402”), one or more intelligent, network-connected, multi-sensing hazard detection units 404 (hereinafter referred to as “smart hazard detectors 404”), one or more intelligent, multi-sensing, network-connected entryway interface devices 406 and 420 (hereinafter referred to as “smart doorbells 406” and “smart door locks 420”), and one or more intelligent, multi-sensing, network-connected alarm systems 422 (hereinafter referred to as “smart alarm systems 422”).

In some implementations, the one or more smart thermostats 402 detect ambient climate characteristics (e.g., temperature and/or humidity) and control an HVAC system 403 accordingly. For example, a respective smart thermostat 402 includes an ambient temperature sensor.

The one or more smart hazard detectors 404 may include thermal radiation sensors directed at respective heat sources (e.g., a stove, oven, other appliances, a fireplace, etc.). For example, a smart hazard detector 404 in a kitchen 453 includes a thermal radiation sensor directed at a stove/oven 412. A thermal radiation sensor may determine the temperature of the respective heat source (or a portion thereof) at which it is directed and may provide corresponding black-body radiation data as output.

The smart doorbell 406 and/or the smart door lock 420 may detect a person's approach to or departure from a location (e.g., an outer door), control doorbell/door locking functionality (e.g., receive user inputs from a portable electronic device 466-1 to actuate the bolt of the smart door lock 420), announce a person's approach or departure via audio or visual means, and/or control settings on a security system (e.g., to activate or deactivate the security system when occupants go and come). In some implementations, the smart doorbell 406 includes some or all of the components and features of the camera 418-1. In some implementations, the smart doorbell 406 includes a camera 418-1, and therefore, is also called “doorbell camera 406” in this document. Cameras 418-1 and/or 418-2 may function as a streaming video camera (similar to smart camera 340 of FIG. 3) and streaming audio device detailed in relation to various embodiments herein. Cameras 418 may be mounted in a location, such as indoors and to a wall or can be moveable and placed on a surface, such as illustrated with camera 418-2. Various embodiments of cameras 418 may be installed indoors or outdoors.

The smart alarm system 422 may detect the presence of an individual within close proximity (e.g., using built-in IR sensors), sound an alarm (e.g., through a built-in speaker, or by sending commands to one or more external speakers), and send notifications to entities or users within/outside of the smart home environment 400. In some implementations, the smart alarm system 422 also includes one or more input devices or sensors (e.g., keypad, biometric scanner, NFC transceiver, microphone) for verifying the identity of a user, and one or more output devices (e.g., display, speaker). In some implementations, the smart alarm system 422 may also be set to an armed mode, such that detection of a trigger condition or event causes the alarm to be sounded unless a disarming action is performed. In embodiments detailed herein, an alarm system may be linked with a service provider other than a provider of cameras 418. As such, remote services provided by the alarm system may be provided by an entity that does not provide the video and/or audio storage and analysis.

In some implementations, the smart home environment 400 includes one or more intelligent, multi-sensing, network-connected wall switches 408 (hereinafter referred to as “smart wall switches 408”), along with one or more intelligent, multi-sensing, network-connected wall plug interfaces 410 (hereinafter referred to as “smart wall plugs 410”). The smart wall switches 408 may detect ambient lighting conditions, detect room-occupancy states, and control a power and/or dim state of one or more lights. In some instances, smart wall switches 408 may also control a power state or speed of a fan, such as a ceiling fan. The smart wall plugs 410 may detect occupancy of a room or enclosure and control supply of power to one or more wall plugs (e.g., such that power is not supplied to the plug if nobody is at home).

In some implementations, the smart home environment 400 of FIG. 4 includes a plurality of intelligent, multi-sensing, network-connected appliances 412 (hereinafter referred to as “smart appliances 412”), such as refrigerators, stoves, ovens, televisions, washers, dryers, lights, stereos, intercom systems, garage-door openers, floor fans, ceiling fans, wall air conditioners, pool heaters, irrigation systems, security systems, space heaters, window AC units, motorized duct vents, and so forth. In some implementations, when plugged in, an appliance may announce itself to the smart home network, such as by indicating what type of appliance it is, and it may automatically integrate with the controls of the smart home. Such communication by the appliance to the smart home may be facilitated by either a wired or wireless communication protocol. The smart home may also include a variety of non-communicating legacy appliances 440, such as old conventional washer/dryers, refrigerators, and the like, which may be controlled by smart wall plugs 410. The smart home environment 400 may further include a variety of partially communicating legacy appliances 442, such as infrared (“IR”) controlled wall air conditioners or other IR-controlled devices, which may be controlled by IR signals provided by the smart hazard detectors 404 or the smart wall switches 408.

In some implementations, the smart home environment 400 includes one or more network-connected cameras 418 that are configured to provide video monitoring and security in the smart home environment 400. The cameras 418 may be used to determine occupancy of the structure 450 and/or particular rooms 452 in the structure 450, and thus may act as occupancy sensors. For example, video captured by the cameras 418 may be processed to identify the presence of an occupant in the structure 450 (e.g., in a particular room 452). Specific individuals may be identified based, for example, on their appearance (e.g., height, face) and/or movement (e.g., their walk/gait). Cameras 418 may additionally include one or more sensors (e.g., IR sensors, motion detectors), input devices (e.g., microphone for capturing audio), and output devices (e.g., speaker for outputting audio). In some implementations, the cameras 418 are each configured to operate in a day mode and in a low-light mode (e.g., a night mode). In some implementations, the cameras 418 each include one or more IR illuminators for providing illumination while the camera is operating in the low-light mode. In some implementations, the cameras 418 include one or more outdoor cameras. In some implementations, the outdoor cameras include additional features and/or components such as weatherproofing and/or solar ray compensation.

The smart home environment 400 may additionally or alternatively include one or more other occupancy sensors (e.g., the smart doorbell 406, smart door locks 420, touch screens, IR sensors, microphones, ambient light sensors, motion detectors, smart nightlights 470, etc.). In some implementations, the smart home environment 400 includes radio-frequency identification (RFID) readers (e.g., in each room 452 or a portion thereof) that determine occupancy based on RFID tags located on or embedded in occupants. For example, RFID readers may be integrated into the smart hazard detectors 404.

The smart home environment 400 may also include communication with devices outside of the physical home but within a proximate geographical range of the home. For example, the smart home environment 400 may include a pool heater monitor 414 that communicates a current pool temperature to other devices within the smart home environment 400 and/or receives commands for controlling the pool temperature. Similarly, the smart home environment 400 may include an irrigation monitor 416 that communicates information regarding irrigation systems within the smart home environment 400 and/or receives control information for controlling such irrigation systems.

Smart home assistant 419 may have one or more microphones that continuously listen to an ambient environment. Smart home assistant 419 may be able to respond to verbal queries posed by a user, possibly preceded by a triggering phrase. Smart home assistant 419 may stream audio and, possibly, video if a camera is integrated as part of the device, to a cloud-based host system 464 (which represents an embodiment of cloud-based host system 200 of FIG. 2). In some embodiments, a user may pose a query to smart home assistant 419 that invokes the intelligent identification system described herein. In such embodiments, the recommendation and installation plan can be sent to the user via email or via a user application accessible by a device such as a smart phone or other computer system. Optionally, the intelligent identification system can ask the user to transition from the smart home assistant 419 to a device, such as portable electronic device 466 with a user application for continuing the interaction.

By virtue of network connectivity, one or more of the smart home devices of FIG. 4 may further allow a user to interact with the device even if the user is not proximate to the device. For example, a user may communicate with a device using a computer (e.g., a desktop computer, laptop computer, or tablet) or other portable electronic device 466 (e.g., a mobile phone, such as a smart phone). A webpage or application may be configured to receive communications from the user and control the device based on the communications and/or to present information about the device's operation to the user. For example, the user may view a current set point temperature for a device (e.g., a stove) and adjust it using a computer. The user may be in the structure during this remote communication or outside the structure.

As discussed above, users may control smart devices in the smart home environment 400 using a network-connected computer or portable electronic device 466. In some examples, some or all of the occupants (e.g., individuals who live in the home) may register their device 466 with the smart home environment 400. Such registration may be made at a central server to authenticate the occupant and/or the device as being associated with the home and to give permission to the occupant to use the device to control the smart devices in the home. An occupant may use their registered device 466 to remotely control the smart devices of the home, such as when the occupant is at work or on vacation. The occupant may also use their registered device to control the smart devices when the occupant is actually located inside the home, such as when the occupant is sitting on a couch inside the home. It should be appreciated that instead of or in addition to registering devices 466, the smart home environment 400 may make inferences about which individuals live in the home and are therefore occupants and which devices 466 are associated with those individuals. As such, the smart home environment may “learn” who is an occupant and permit the devices 466 associated with those individuals to control the smart devices of the home.

In some implementations, in addition to containing processing and sensing capabilities, devices 402, 404, 406, 408, 410, 412, 414, 416, 418, 420, and/or 422 (collectively referred to as “the smart devices”) are capable of data communications and information sharing with other smart devices, a central server or cloud-computing system, and/or other devices that are network-connected. Data communications may be carried out using any of a variety of custom or standard wireless protocols (e.g., IEEE 802.15.4, Wi-Fi, ZigBee, 6LoWPAN, Thread, Z-Wave, Bluetooth Smart, ISA100.5A, WirelessHART, MiWi, etc.) and/or any of a variety of custom or standard wired protocols (e.g., Ethernet, HomePlug, etc.), or any other suitable communication protocol, including communication protocols not yet developed as of the filing date of this document.

To assist in intelligent identification and provisioning of devices and services for the smart home, any of the information collected by smart devices can be used to identify the habits of the occupants and other information related to the structure 450 or the occupants. This information can be used to generate the recommendation and installation plan as well as to generate correlated information (e.g., demographic group or purchasing power).

In some implementations, the smart devices serve as wireless or wired repeaters. In some implementations, a first one of the smart devices communicates with a second one of the smart devices via a wireless router. The smart devices may further communicate with each other via a connection (e.g., network interface 460) to a network, such as the Internet. Through the Internet, the smart devices may communicate with a cloud-based host system 464 (also called a cloud-based server system, central server system, and/or a cloud-computing system herein), which represents an embodiment of cloud-based host system 200 of FIG. 2. Cloud-based server system 464 may be associated with a manufacturer, support entity, or service provider associated with the smart device(s). In some implementations, a user is able to contact user support using a smart device itself rather than needing to use other communication means, such as a telephone or Internet-connected computer. In some implementations, software updates are automatically sent from cloud-based server system 464 to smart devices (e.g., when available, when purchased, or at routine intervals).

In some implementations, the network interface 460 includes a conventional network device (e.g., a router), and the smart home environment 400 of FIG. 4 includes a hub device 480 that is communicatively coupled to the network(s) 462 directly or via the network interface 460. The hub device 480 is further communicatively coupled to one or more of the above intelligent, multi-sensing, network-connected devices (e.g., smart devices of the smart home environment 400). Each of these smart devices optionally communicates with the hub device 480 using one or more radio communication networks available at least in the smart home environment 400 (e.g., ZigBee, Z-Wave, Insteon, Bluetooth, Wi-Fi and other radio communication networks). In some implementations, the hub device 480 and devices coupled with/to the hub device can be controlled and/or interacted with via an application running on a smart phone, household controller, laptop, tablet computer, game console or similar electronic device. In some implementations, a user of such controller application can view the status of the hub device or coupled smart devices, configure the hub device to interoperate with smart devices newly introduced to the home network, commission new smart devices, and adjust or view settings of connected smart devices, etc. In some implementations the hub device extends capabilities of low capability smart devices to match capabilities of the highly capable smart devices of the same type, integrates functionality of multiple different device types—even across different communication protocols—and is configured to streamline adding of new devices and commissioning of the hub device. In some implementations, hub device 480 further includes a local storage device for storing data related to, or output by, smart devices of smart home environment 400. In some implementations, the data includes one or more of: video data output by a camera device, metadata output by a smart device, settings information for a smart device, usage logs for a smart device, and the like.

In some implementations, smart home environment 400 includes a local storage device 490 for storing data related to, or output by, smart devices of smart home environment 400. In some implementations, the data includes one or more of: video data output by a camera device (e.g., cameras 418 or doorbell camera 406), metadata output by a smart device, settings information for a smart device, usage logs for a smart device, and the like. In some implementations, local storage device 490 is communicatively coupled to one or more smart devices via a smart home network (e.g., smart home network 202, FIG. 2). In some implementations, local storage device 490 is selectively coupled to one or more smart devices via a wired and/or wireless communication network. In some implementations, local storage device 490 is used to store video data when external network conditions are poor. For example, local storage device 490 is used when an encoding bitrate of cameras 418 exceeds the available bandwidth of the external network (e.g., network(s) 462). In some implementations, local storage device 490 temporarily stores video data from one or more cameras (e.g., cameras 418) prior to transferring the video data to a server system (e.g., server system 464).

Further included and illustrated in the exemplary smart home environment 400 of FIG. 4 are service robots 468, each configured to carry out, in an autonomous manner, any of a variety of household tasks. For some embodiments, the service robots 468 can be respectively configured to perform floor sweeping, floor washing, etc. in a manner similar to that of known commercially available devices such as the Roomba™ and Scooba™ products sold by iRobot, Inc. of Bedford, Mass. Tasks such as floor sweeping and floor washing can be considered as “away” or “while-away” tasks for purposes of the instant description, as it is generally more desirable for these tasks to be performed when the occupants are not present. For other embodiments, one or more of the service robots 468 are configured to perform tasks such as playing music for an occupant, serving as a localized thermostat for an occupant, serving as a localized air monitor/purifier for an occupant, serving as a localized baby monitor, serving as a localized hazard detector for an occupant, and so forth, it being generally more desirable for such tasks to be carried out in the immediate presence of the human occupant. For purposes of the instant description, such tasks can be considered as “human-facing” or “human-centric” tasks. Further, such service robots may have one or more cameras and/or microphones that enable service robots 468 to stream video and/or audio to cloud-based host system 464 (and thus perform the functions of a streaming video camera similar to one of cameras 418).

When serving as a localized air monitor/purifier for an occupant, a particular service robot 468 can be considered to be facilitating what can be called a “personal health-area network” for the occupant, with the objective being to keep the air quality in the occupant's immediate space at healthy levels. Alternatively or in conjunction therewith, other health-related functions can be provided, such as monitoring the temperature or heart rate of the occupant (e.g., using finely remote sensors, near-field communication with on-person monitors, etc.). When serving as a localized hazard detector for an occupant, a particular service robot 468 can be considered to be facilitating what can be called a “personal safety-area network” for the occupant, with the objective being to ensure there is no excessive carbon monoxide, smoke, fire, etc., in the immediate space of the occupant. Methods analogous to those described above for personal comfort-area networks in terms of occupant identifying and tracking are likewise applicable for personal health-area network and personal safety-area network embodiments.

According to some embodiments, the above-referenced facilitation of personal comfort-area networks, personal health-area networks, personal safety-area networks, and/or other such human-facing functionalities of the service robots 468, are further enhanced by logical integration with other smart sensors in the home according to rules-based inferencing techniques or artificial intelligence techniques for achieving better performance of those human-facing functionalities and/or for achieving those goals in energy-conserving or other resource-conserving ways. Thus, for one embodiment relating to personal health-area networks, the air monitor/purifier service robot 468 can be configured to detect whether a household pet is moving toward the currently settled location of the occupant (e.g., using on-board sensors and/or by data communications with other smart home sensors along with rules-based inferencing/artificial intelligence techniques), and if so, the air purifying rate is immediately increased in preparation for the arrival of more airborne pet dander. For another embodiment relating to personal safety-area networks, the hazard detector service robot 468 can be advised by other smart home sensors that the temperature and humidity levels are rising in the kitchen, which is nearby the occupant's current dining room location, and responsive to this advisory, the hazard detector service robot 468 will temporarily raise a hazard detection threshold, such as a smoke detection threshold, under an inference that any small increases in ambient smoke levels will most likely be due to cooking activity and not due to a genuinely hazardous condition.

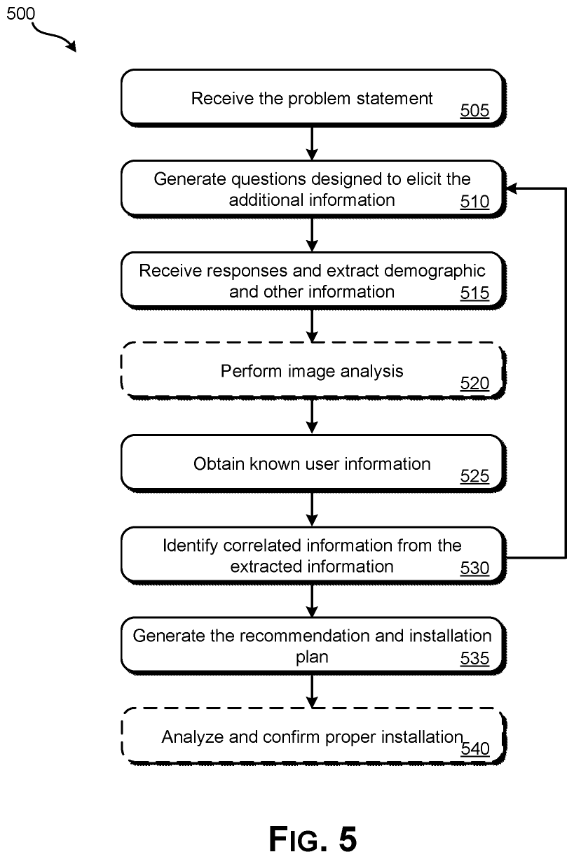

Various methods may be performed using the previously detailed systems and devices. FIG. 5 illustrates an embodiment of a method 500 for intelligent identification and provisioning of devices and services in a smart home. Method 500 may be performed using the systems of FIGS. 1-3. At block 505, the intelligent identification system can receive the assistance query or behavior information. For example, the prospective user can ask a question or provide the assistance query through a user application. As another example, behavior information detected by smart home devices within the prospective user's home may be transmitted by the smart home device to the intelligent identification system. At block 510, the intelligent identification system can generate questions designed to elicit additional information from the prospective user. For example, after receiving the initial question or assistance query, initial questions can be asked if the information is not already available about the prospective user. For example, the size of the user's home or images of the user's home can be requested. A supervised learning algorithm may be used to generate models based on existing user information that includes characteristic data, choice data (e.g., smart home devices and services used in the existing user's home), and performance metrics associated with the choice data (e.g., metrics indicating usage or satisfaction with the existing user's devices or services). The information obtained about the user may be fit to a model that includes interview questions the intelligent identification system can extract from the model for use in the interaction with this prospective user.

At block 515, the intelligent identification system can receive responses to the interview questions and extract demographic and other information from the responses. For example, text analysis can be performed to extract information about the user's home or user. For example, input analysis and extraction module 251 as described with respect to FIG. 2 can receive the input/responses and extract user specific, demographic, or inferred information. Optionally, image analysis can be performed at 520 to extract user information including demographic, inferred, or behavioral information.

At block 525, the intelligent identification system can obtain available user information. For example, the intelligent identification system can extract relevant information such as user specific and demographic information from a customer database and use that information to identify other user specific information. For example, the input analysis and extraction module 251 as described with respect to FIG. 2 can receive the input/responses. The input analysis and extraction module 251 can analyze the input and provide any user information (e.g., username, customer ID, user's full name and address, and so forth) to the user identification module 252. The user identification module 252 can use the provided user information to identify a specific user in a customer database, for example, and extract details about the specific user from the database, such as purchase history, address, age, gender, marital status, and so forth.

At block 530, the intelligent identification system can identify correlated information from the extracted information. For example, the input analysis and extraction module 251 as described with respect to FIG. 2 can provide extracted demographic information to correlation identification module 253. The correlation identification module 253 can identify correlation information and provide it to the interaction assistance module 254. For example, the correlation identification module 253 can identify correlation information about the user's location, the user's demographic group, correlation information inferred from image analysis, and so forth. Based on the information extracted, obtained, and identified in blocks 515, 520, 525, and 530, additional questions can be generated to elicit more information at 510, and the blocks can continue executing until sufficient information is obtained to provide an optimized recommendation, which may include an installation plan.

At block 535, the intelligent identification system can generate the recommendation and optionally the installation plan. The recommendation can be based on the assistance query, the user specific information (e.g., house location, house size, number of occupants, income, purchase history, and so forth), and the correlated information (e.g., demographic group purchase history patterns, estimated purchasing power of the user, other inferred information). For example, a reinforcement learning algorithm may be used to identify characteristic data in the existing user database that matches the prospective user's data. Associated choice data and performance metrics for the associated choice data may be used from the matching characteristic data to generate the recommendation for the prospective user. Choice data (e.g., smart home devices and/or smart home services) that have associated performance metrics that indicate existing user satisfaction, high usage, conversion from a free trial, or other positive feedback may be selected for the recommendation and weights associated with the recommended products (i.e., smart home devices and smart home services) can be further based on the performance metrics. The recommendation may optionally include an installation plan.

Optionally, at block 540, the intelligent identification system can analyze and confirm the proper installation. After installation, information about the installation can be obtained or provided by, for example, the user or the installed smart devices. The intelligent identification system can compare the recommendations and installation plan with the information about the installation including the devices installed, the location of installation of each device, and the configurations of each device (e.g., camera angle installation). The intelligent identification system can, based on the analysis, provide a notification to the user providing compliance information. For example, if the installation is not in compliance with the installation plan, the notification can provide a recommendation for modifying the installation to comply with the installation plan. If the installation is in compliance with the installation plan, the notification can inform the user that the installation is in compliance. For example, installation analysis and confirmation module 256 can perform the analysis and generate the notifications. In some embodiments a notification is not provided. In some embodiments, the compliance (or failure to comply) may be used as a performance metric associated with the choice data (the recommended products) for that user's characteristic data in the existing user database. The reinforcement learning algorithm may use the compliance metric to learn and provide better future recommendations to other users.

FIG. 6 illustrates an embodiment 600 of a user interface 610 on a user device for interacting with the intelligent identification system 140. User interface 610 may be presented as part of a native application executed by the user device or webpage presented by a browser executed by the user device. In interface 610, a natural language chat dialog with intelligent identification system 140 can be used to obtain information from the user for use in generating the recommendation and installation plan. In other embodiments, such information may be obtained and the recommendation and installation plan may be provided via a webpage, a smart home device 110 (e.g., via audio, video, or a visual user interface on a smart home device 110), or in some other form. Interface 610 can prompt for specific information and can accept information from the user in various formats including audio (e.g., speaking), visual (e.g., using a camera, such as a smart phone camera, to take images or video), and text.

As shown in user interface 610, the user can begin an interaction by providing an assistance query of, for example, “What can I do to protect against the rash of local break-ins?” The input analysis and extraction module 251 can analyze the input and identify the assistance query as an exterior security issue based on identifying “protect” and “break-ins” as keywords, for example. In some cases, the user may not be known because, for example, the user does not provide identifying information and the user is not logged into an application. The interaction assistance module 254 can initially request user information to identify the user. For example, the interaction assistance module 254 can generate the question “I noticed you're not logged in. I can help you more effectively if you provide your username.” The user can choose to not respond, respond negatively, end the interaction, provide the username, or provide some other information including a new or different question. If the user does not provide the username, the intelligent identification system can use the information provided to provide a recommendation. If the user provides the username, as in the example in user interface 610, the input analysis and extraction module 251 can extract the username from the response and provide it to the user identification module 252. The user identification module 252 can query a customer support user database or a sales user database, for example, to obtain details about the user including the user's name (e.g., John Doe), the user's address (e.g., an address in Denver, Colo.), the user's purchase history (e.g., a smart alarm system with 2 interior motion sensors and 8 window open/close/motion/breakage sensors, a smart thermostat, and 7 smart hazard detectors all installed throughout the users ranch style home), the user's age (e.g., 46), the user's marital/family status (e.g., married with no kids), and so forth. Given the available information, the correlation identification module 253 can generate correlated information such as, for example, an estimated purchasing power based on the user's address and past purchasing history (e.g., purchasing power is approximately $3000-$3200 based on the address is in a middle class neighborhood and the user has many devices.) As another example, the correlation identification module 253 can identify purchase history patterns of members of the user's neighborhood (e.g., 70% of the neighborhood has an alarm system, 50% of the neighborhood has a smart thermostat, and 25% of the neighborhood has a smart doorbell with camera). The interaction assistance module 254 can, based on the assistance query being an exterior security issue, request exterior images by stating “Thanks, John. It would be useful to get a visual. Can you use the ‘Provide Image’ button below to take some pictures or a video of the exterior perimeter of your house?”

The user can upload a video clip of the exterior perimeter of the home. The input analysis and extraction module 251 can analyze the video clip and determine that the exterior perimeter of the home suggests that it is a 2800 square foot home that includes a garage, three exterior doors (one in the front, one in the back, and one entering the side of the garage), and 10 windows. Based on the assistance query, the image analysis, the user specific information, and the correlated information, the device installation plan recommendation module 255 can generate a recommendation and installation plan. For example, the device installation plan recommendation module 255 can identify an initial recommendation including a smart alarm system costing $499 with 10 window open/close/motion/breakage sensors costing $59 each and 3 door open/close/motion/breakage sensors costing $59 each (one sensor for each window and door), a smart doorbell with camera costing $299, and 6 outdoor smart cameras costing $349 each to be positioned around the perimeter of the home. After comparing the initial recommendation with the user's purchase history, the device installation plan recommendation module 255 can adjust the recommendation to remove the smart alarm system and 8 window open/close/motion/breakage sensors, leaving a modified recommendation of 2 window open/close/motion/breakage sensors costing $59 each and 3 door open/close/motion/breakage sensors costing $59 each (one sensor for each window and door), a smart doorbell with camera costing $299, and 6 outdoor smart cameras costing $349 each to be positioned around the perimeter of the home with a total cost of $2688. After determining that the adjusted recommendation complies with the user's purchasing power, the neighborhood purchase history patterns, and the assistance query, the device installation plan recommendation module 255 can provide the recommendation and installation plan to the user. The recommendation and installation plan can include images identifying the recommended installation locations of the smart cameras on the perimeter of the user's home. The recommendation and installation plan can also include an explanation or diagram of which where and how to install the open/close/motion/breakage sensors on the doors and windows. The recommendation and installation plan can also include installation instructions for the smart doorbell. Further, the recommendation and installation plan can include a natural language explanation of the features and benefits of each of the recommended devices specifically highlighting features that make the smart device a good option for including in the solution to the assistance query.

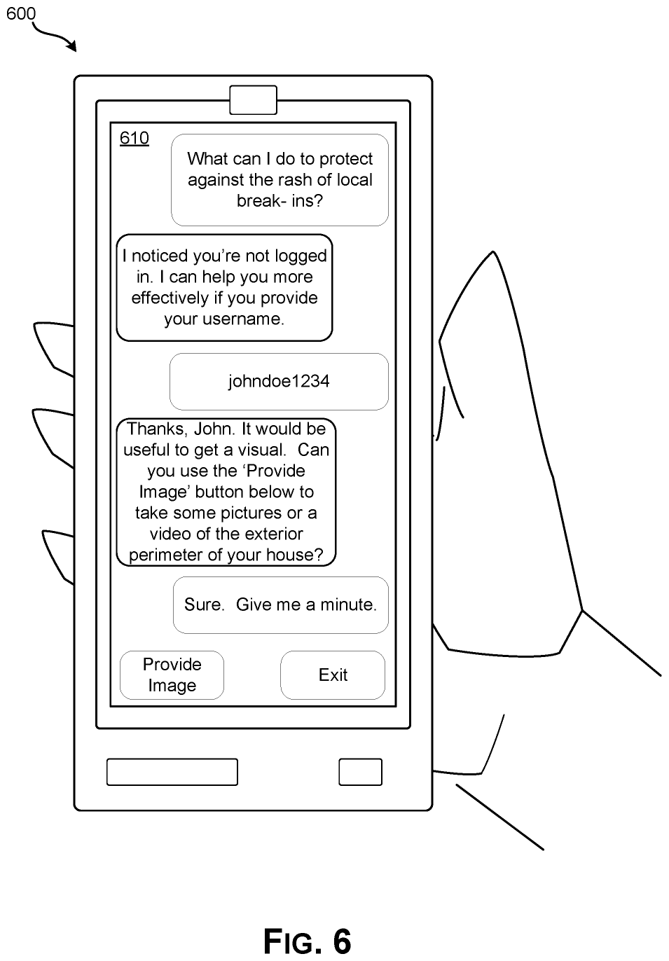

In some implementations, the systems and methods of the present disclosure can include or otherwise leverage one or more machine-learned models to identify interview questions based on characteristic data of existing users. FIGS. 7-11 provide additional details specific to machine-learned algorithms and details of how they function.

FIG. 7 depicts a block diagram of an example machine-learned model according to example implementations of the present disclosure. As illustrated in FIG. 7, in some implementations, the machine-learned model is trained to fit input data of one or more types to other data of one or more types, and provide output data of one or more types based on the fitting. Machine-learned models are a set of parameters that are persisted in memory to be used multiple times. Thus, FIG. 7 illustrates the machine-learned model performing inference.

In some implementations, the input data can include one or more features that are associated with an instance or an example. In some implementations, the one or more features associated with the instance or example can be organized into a feature vector. In some implementations, the output data can include one or more predictions. Predictions can also be referred to as inferences. Thus, given features associated with a particular instance, the machine-learned model can output a prediction for such instance based on the features.

The machine-learned model can be or include one or more of various different types of machine-learned models. In particular, in some implementations, the machine-learned model can perform classification, regression, clustering, anomaly detection, recommendation generation, and/or other tasks.

In some implementations, the machine-learned model can perform various types of classification based on the input data. For example, the machine-learned model can perform binary classification or multiclass classification. In binary classification, the output data can include a classification of the input data into one of two different classes. In multiclass classification, the output data can include a classification of the input data into one (or more) of more than two classes. The classifications can be single label or multi-label.

In some implementations, the machine-learned model can perform discrete categorical classification in which the input data is simply classified into one or more classes or categories.

In some implementations, the machine-learned model can perform classification in which the machine-learned model provides, for each of one or more classes, a numerical value descriptive of a degree to which it is believed that the input data should be classified into the corresponding class. In some instances, the numerical values provided by the machine-learned model can be referred to as “confidence scores” that are indicative of a respective confidence associated with classification of the input into the respective class. In some implementations, the confidence scores can be compared to one or more thresholds to render a discrete categorical prediction. In some implementations, only a certain number of classes (e.g., one) with the relatively largest confidence scores can be selected to render a discrete categorical prediction.

In some implementations, the machine-learned model can provide a probabilistic classification. For example, the machine-learned model can be able to predict, given a sample input, a probability distribution over a set of classes. Thus, rather than outputting only the most likely class to which the sample input should belong, the machine-learned model can output, for each class, a probability that the sample input belongs to such class. In some implementations, the probability distribution over all possible classes can sum to one. In some implementations, a softmax function or layer can be used to squash a set of real values respectively associated with the possible classes to a set of real values in the range (0, 1) that sum to one.

In some implementations, the probabilities provided by the probability distribution can be compared to one or more thresholds to render a discrete categorical prediction. In some implementations, only a certain number of classes (e.g., one) with the relatively largest predicted probability can be selected to render a discrete categorical prediction.

In some implementations in which the machine-learned model performs classification, the machine-learned model can be trained using supervised learning techniques. For example, the machine-learned model can be trained on a training dataset that includes training examples labeled as belonging (or not belonging) to one or more classes. Further details regarding supervised training techniques are provided below.

In some implementations, the machine-learned model can provide output data in the form of one or more recommendations. For example, the machine-learned model can be included in a recommendation system or engine. As an example, given input data that describes previous outcomes for certain entities (e.g., a score, ranking, or rating indicative of an amount of success or enjoyment), the machine-learned model can output a suggestion or recommendation of one or more additional entities that, based on the previous outcomes, are expected to have a desired outcome (e.g., elicit a score, ranking, or rating indicative of success or enjoyment). As one example, given input data descriptive of a number of products purchased or rated highly by a user, a recommendation system can output a suggestion or recommendation of an additional product that the user might enjoy or wish to purchase.

In some implementations, the machine-learned model can act as an agent within an environment. For example, the machine-learned model can be trained using reinforcement learning, which will be discussed in further detail below.

As described above, the machine-learned model can be or include one or more of various different types of machine-learned models. Examples of such different types of machine-learned models are provided below for illustration. One or more of the example models described below can be used (e.g., combined) to provide the output data in response to the input data. Additional models beyond the example models provided below can be used as well.

In some implementations, the machine-learned model can be or include one or more classifier models such as, for example, linear classification models; quadratic classification models; and so forth.

In some implementations, the machine-learned model can be or include one or more instance-based learning models such as, for example, learning vector quantization models; self-organizing map models; locally weighted learning models; and so forth.

In some implementations, the machine-learned model can be or include one or more artificial neural networks (also referred to simply as neural networks). A neural network can include a group of connected nodes, which also can be referred to as neurons or perceptrons. A neural network can be organized into one or more layers. Neural networks that include multiple layers can be referred to as “deep” networks. A deep network can include an input layer, an output layer, and one or more hidden layers positioned between the input layer and the output layer. The nodes of the neural network can be connected or non-fully connected.

In some implementations, one or more neural networks can be used to provide an embedding based on the input data. For example, the embedding can be a representation of knowledge abstracted from the input data into one or more learned dimensions. In some instances, embeddings can be a useful source for identifying related entities. In some instances embeddings can be extracted from the output of the network, while in other instances embeddings can be extracted from any hidden node or layer of the network (e.g., a close to final but not final layer of the network). Embeddings can be useful for performing auto suggest next video, product suggestion, entity or object recognition, etc. In some instances, embeddings be useful inputs for downstream models. For example, embeddings can be useful to generalize input data (e.g., search queries) for a downstream model or processing system.

In some implementations, the machine-learned model can perform or be subjected to one or more reinforcement learning techniques such as Markov decision processes; dynamic programming; Q functions or Q-learning; value function approaches; deep Q-networks; differentiable neural computers; asynchronous advantage actor-critics; deterministic policy gradient; etc.

In some implementations, the machine-learned model can be used to preprocess the input data for subsequent input into another model. For example, the machine-learned model can perform dimensionality reduction techniques and embeddings (e.g., matrix factorization, principal components analysis, singular value decomposition, word2vec/GLOVE, and/or related approaches); clustering; and even classification and regression for downstream consumption. Many of these techniques have been discussed above and will be further discussed below.

Referring again to FIG. 7, and as discussed above, the machine-learned model can be trained or otherwise configured to receive the input data and, in response, provide the output data. The input data can include different types, forms, or variations of input data. As examples, in various implementations, the input data can include characteristic data of existing users as described herein.

In some implementations, the machine-learned model can receive and use the input data in its raw form. In some implementations, the raw input data can be preprocessed. Thus, in addition or alternatively to the raw input data, the machine-learned model can receive and use the preprocessed input data.

In some implementations, preprocessing the input data can include extracting one or more additional features from the raw input data. For example, feature extraction techniques can be applied to the input data to generate one or more new, additional features. Example feature extraction techniques include edge detection; corner detection; blob detection; ridge detection; scale-invariant feature transform; motion detection; optical flow; Hough transform; etc.

In some implementations, the extracted features can include or be derived from transformations of the input data into other domains and/or dimensions. As an example, the extracted features can include or be derived from transformations of the input data into the frequency domain. For example, wavelet transformations and/or fast Fourier transforms can be performed on the input data to generate additional features.

In some implementations, the extracted features can include statistics calculated from the input data or certain portions or dimensions of the input data. Example statistics include the mode, mean, maximum, minimum, or other metrics of the input data or portions thereof.

As another example preprocessing technique, portions of the input data can be imputed. For example, additional synthetic input data can be generated through interpolation and/or extrapolation.

As another example preprocessing technique, some or all of the input data can be scaled, standardized, normalized, generalized, and/or regularized. Example regularization techniques include ridge regression; least absolute shrinkage and selection operator (LASSO); elastic net; least-angle regression; cross-validation; L1 regularization; L2 regularization; etc. As one example, some or all of the input data can be normalized by subtracting the mean across a given dimension's feature values from each individual feature value and then dividing by the standard deviation or other metric.

As another example preprocessing technique, some or all or the input data can be quantized or discretized. As yet another example, qualitative features or variables included in the input data can be converted to quantitative features or variables. For example, one hot encoding can be performed.

In some implementations, during training, the input data can be intentionally deformed in any number of ways to increase model robustness, generalization, or other qualities. Example techniques to deform the input data include adding noise; changing color, shade, or hue; magnification; segmentation; amplification; etc.

Referring again to FIG. 7, in response to receipt of the input data, the machine-learned model can provide the output data. The output data can include different types, forms, or variations of output data. As examples, in various implementations, the output data can include the interview questions best suited to obtain the information relevant to addressing the identified issue in the assistance query and/or the behavior information.

As discussed above, in some implementations, the output data can include various types of classification data (e.g., binary classification, multiclass classification, single label, multi-label, discrete classification, regressive classification, probabilistic classification, etc.) or can include various types of regressive data (e.g., linear regression, polynomial regression, nonlinear regression, simple regression, multiple regression, etc.). In other instances, the output data can include clustering data, anomaly detection data, recommendation data, or any of the other forms of output data discussed above.

In some implementations, the output data can influence downstream processes or decision making. As one example, in some implementations, the output data can be interpreted and/or acted upon by a rules-based regulator.

Thus, the present disclosure provides systems and methods that include or otherwise leverage one or more machine-learned models to identify interview questions based on characteristic data of the user. Another machine-learned model may identify recommended products and optionally an installation plan based on successful outcomes for other users similarly situated to the user having used the recommended products. Any of the different types or forms of input data described above can be combined with any of the different types or forms of machine-learned models described above to provide any of the different types or forms of output data described above.

The systems and methods of the present disclosure can be implemented by or otherwise executed on one or more computing devices. Example computing devices include user computing devices (e.g., laptops, desktops, and mobile computing devices such as tablets, smartphones, wearable computing devices, etc.); embedded computing devices (e.g., devices embedded within a vehicle, camera, image sensor, industrial machine, satellite, gaming console or controller, or home appliance such as a refrigerator, thermostat, energy meter, home energy manager, smart home assistant, etc.); server computing devices (e.g., database servers, parameter servers, file servers, mail servers, print servers, web servers, game servers, application servers, etc.); dedicated, specialized model processing or training devices; virtual computing devices; other computing devices or computing infrastructure; or combinations thereof.

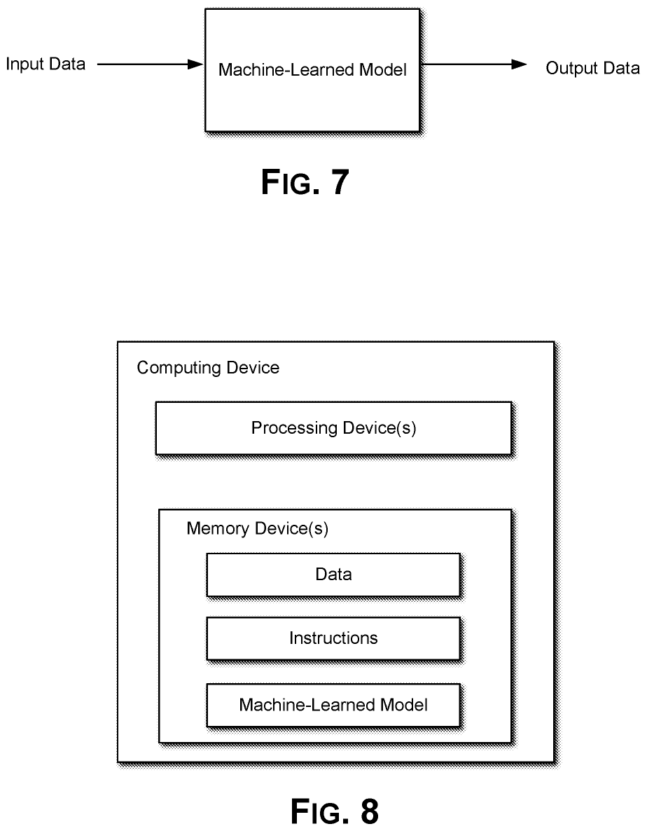

Thus, in some implementations, the machine-learned model can be stored at and/or implemented locally by an embedded device or a user computing device such as a mobile device. Output data obtained through local implementation of the machine-learned model at the embedded device or the user computing device can be used to improve performance of the embedded device or the user computing device (e.g., an application implemented by the embedded device or the user computing device). As one example, FIG. 8 illustrates a block diagram of an example computing device that stores and implements a machine-learned model locally.

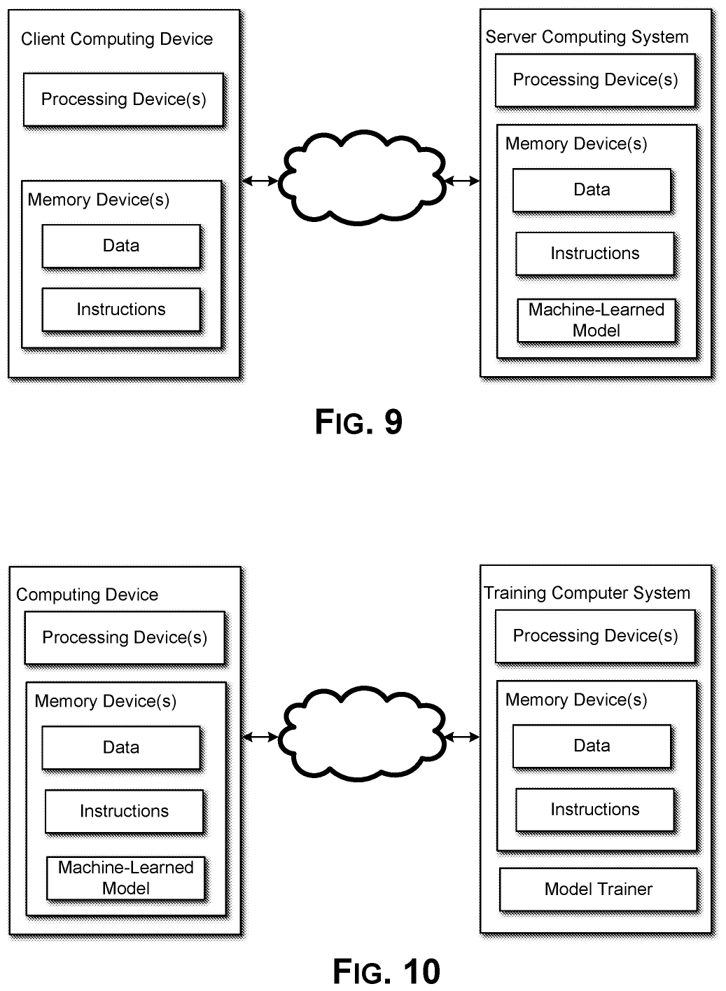

In other implementations, the machine-learned model can be stored at and/or implemented by a server computing device. In some instances, output data obtained through implementation of the machine-learned model at the server computing device can be used to improve other server tasks or can be used by other non-user devices to improve services performed by or for such other non-user devices. For example, the output data can improve other downstream processes performed by the server computing device for a user computing device or embedded computing device. In other instances, output data obtained through implementation of the machine-learned model at the server computing device can be sent to and used by a user computing device, an embedded computing device, or some other client device. For example, the server computing device can be said to perform machine learning as a service. As one example, FIG. 9 illustrates a block diagram of an example client computing device that can communicate over a network with an example server computing system that includes a machine-learned model.

In yet other implementations, different respective portions of the machine-learned model can be stored at and/or implemented by some combination of a user computing device; an embedded computing device; a server computing device; etc.

Computing devices can perform graph processing techniques or other machine learning techniques using one or more machine learning platforms, frameworks, and/or libraries, such as, for example, TensorFlow, Caffe/Caffe2, Theano, Torch/PyTorch, MXnet, CNTK, etc.

Computing devices can be distributed at different physical locations and connected via one or more networks. Distributed computing devices can operate according to sequential computing architectures, parallel computing architectures, or combinations thereof. In one example, distributed computing devices can be controlled or guided through use of a parameter server.

In some implementations, multiple instances of the machine-learned model can be parallelized to provide increased processing throughput. For example, the multiple instances of the machine-learned model can be parallelized on a single processing device or computing device or parallelized across multiple processing devices or computing devices.

Each computing device that implements the machine-learned model or other aspects of the present disclosure can include a number of hardware components that enable performance of the techniques described herein. For example, each computing device can include one or more memory devices that store some or all of the machine-learned model. For example, the machine-learned model can be a structured numerical representation that is stored in memory. The one or more memory devices can also include instructions for implementing the machine-learned model or performing other operations. Example memory devices include RAM, ROM, EEPROM, EPROM, flash memory devices, magnetic disks, etc., and combinations thereof.

Each computing device can also include one or more processing devices that implement some or all of the machine-learned model and/or perform other related operations. Example processing devices include one or more of: a central processing unit (CPU); a visual processing unit (VPU); a graphics processing unit (GPU); a tensor processing unit (TPU); a neural processing unit (NPU); a neural processing engine; a core of a CPU, VPU, GPU, TPU, NPU or other processing device; an application specific integrated circuit (ASIC); a field programmable gate array (FPGA); a co-processor; a controller; or combinations of the processing devices described above. Processing devices can be embedded within other hardware components such as, for example, an image sensor, accelerometer, etc.

Hardware components (e.g., memory devices and/or processing devices) can be spread across multiple physically distributed computing devices and/or virtually distributed computing systems.

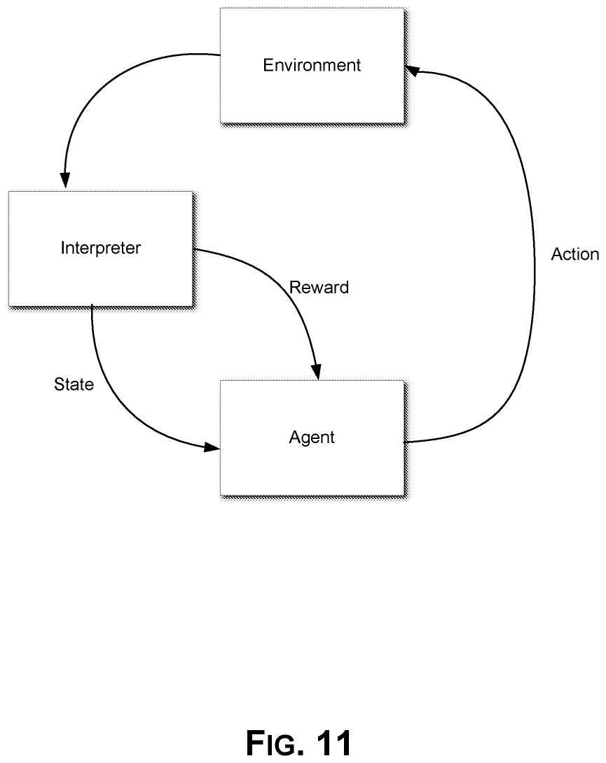

In some implementations, the machine-learned models described herein can be trained at a training computing system and then provided for storage and/or implementation at one or more computing devices, as described above. For example, a model trainer can be located at the training computing system. The training computing system can be included in or separate from the one or more computing devices that implement the machine-learned model. As one example, FIG. 10 illustrates a block diagram of an example computing device in communication with an example training computing system that includes a model trainer.

In some implementations, the model can be trained in an offline fashion or an online fashion. In offline training (also known as batch learning), a model is trained on the entirety of a static set of training data. In online learning, the model is continuously trained (or re-trained) as new training data becomes available (e.g., while the model is used to perform inference).

In some implementations, the model trainer can perform centralized training of the machine-learned models (e.g., based on a centrally stored dataset). In other implementations, decentralized training techniques such as distributed training, federated learning, or the like can be used to train, update, or personalize the machine-learned models.

The machine-learned models described herein can be trained according to one or more of various different training types or techniques. For example, in some implementations, the machine-learned models can be trained using supervised learning, in which the machine-learned model is trained on a training dataset that includes instances or examples that have labels. The labels can be manually applied by experts, generated through crowd-sourcing, or provided by other techniques (e.g., by physics-based or complex mathematical models). In some implementations, if the user has provided consent, the training examples can be provided by the user computing device. In some implementations, this process can be referred to as personalizing the model.

In some implementations, training data can include examples of the input data that have been assigned labels that correspond to the output data.

In some implementations, the machine-learned model can be trained by optimizing an objective function. For example, in some implementations, the objective function can be or include a loss function that compares (e.g., determines a difference between) output data generated by the model from the training data and labels (e.g., ground-truth labels) associated with the training data. For example, the loss function can evaluate a sum or mean of squared differences between the output data and the labels. As another example, the objective function can be or include a cost function that describes a cost of a certain outcome or output data. Other objective functions can include margin-based techniques such as, for example, triplet loss or maximum-margin training.

One or more of various optimization techniques can be performed to optimize the objective function. For example, the optimization technique(s) can minimize or maximize the objective function. Example optimization techniques include Hessian-based techniques and gradient-based techniques, such as, for example, coordinate descent; gradient descent (e.g., stochastic gradient descent); subgradient methods; etc. Other optimization techniques include black box optimization techniques and heuristics.

In some implementations, backward propagation of errors can be used in conjunction with an optimization technique (e.g., gradient based techniques) to train a model (e.g., a multi-layer model such as an artificial neural network). For example, an iterative cycle of propagation and model parameter (e.g., weights) update can be performed to train the model. Example backpropagation techniques include truncated backpropagation through time, Levenberg-Marquardt backpropagation, etc.

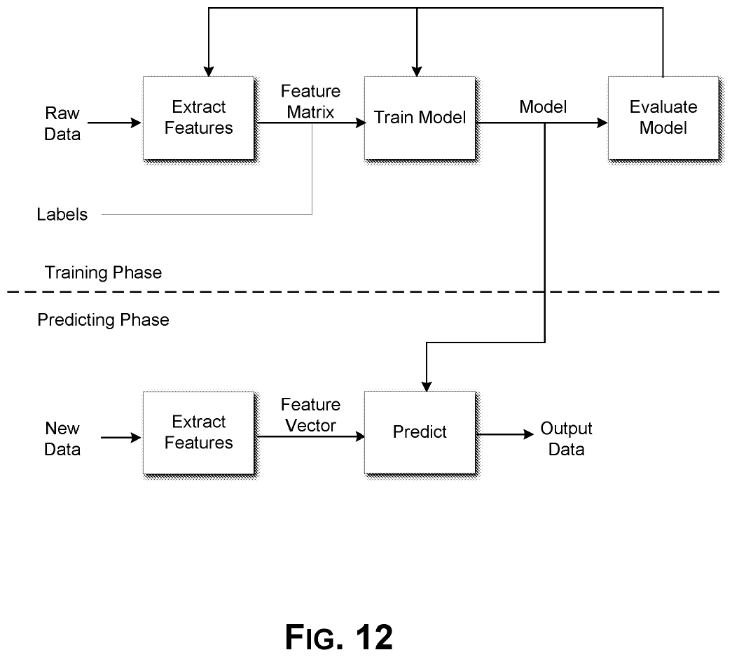

In some implementations, the machine-learned models described herein can be trained using reinforcement learning. In reinforcement learning, an agent (e.g., model) can take actions in an environment and learn to maximize rewards and/or minimize penalties that result from such actions. Reinforcement learning can differ from the supervised learning problem in that correct input/output pairs are not presented, nor sub-optimal actions explicitly corrected. FIG. 11 illustrates an example reinforcement learning system workflow.

FIG. 12 illustrates an example supervised learning workflow that visually provides additional detail according to some embodiments. Supervised learning is the process of training a predictive model. In supervised learning, the target values provide a way for the agent to know how well it has learned the desired task. Accordingly, given the existing customer data set, the supervised learning algorithm attempts to optimize a function (e.g., the model) to find the feature values that result in the target output.

In some implementations, one or more generalization techniques can be performed during training to improve the generalization of the machine-learned model. Generalization techniques can help reduce overfitting of the machine-learned model to the training data. Example generalization techniques include dropout techniques; weight decay techniques; batch normalization; early stopping; subset selection; stepwise selection; etc.

In some implementations, the machine-learned models described herein can include or otherwise be impacted by a number of hyperparameters, such as, for example, learning rate, number of layers, number of nodes in each layer, number of leaves in a tree, number of clusters; etc. Hyperparameters can affect model performance. Hyperparameters can be hand selected or can be automatically selected through application of techniques such as, for example, grid search; black box optimization techniques (e.g., Bayesian optimization, random search, etc.); gradient-based optimization; etc. Example techniques and/or tools for performing automatic hyperparameter optimization include Hyperopt; Auto-WEKA; Spearmint; Metric Optimization Engine (MOE); etc.

In some implementations, various techniques can be used to optimize and/or adapt the learning rate when the model is trained. Example techniques and/or tools for performing learning rate optimization or adaptation include Adagrad; Adaptive Moment Estimation (ADAM); Adadelta; RMSprop; etc.

In some implementations, transfer learning techniques can be used to provide an initial model from which to begin training of the machine-learned models described herein.

In some implementations, the machine-learned models described herein can be included in different portions of computer-readable code on a computing device. In one example, the machine-learned model can be included in a particular application or program and used (e.g., exclusively) by such particular application or program. Thus, in one example, a computing device can include a number of applications and one or more of such applications can contain its own respective machine learning library and machine-learned model(s).

In another example, the machine-learned models described herein can be included in an operating system of a computing device (e.g., in a central intelligence layer of an operating system) and can be called or otherwise used by one or more applications that interact with the operating system. In some implementations, each application can communicate with the central intelligence layer (and model(s) stored therein) using an application programming interface (API) (e.g., a common, public API across all applications).

In some implementations, the central intelligence layer can communicate with a central device data layer. The central device data layer can be a centralized repository of data for the computing device. The central device data layer can communicate with a number of other components of the computing device, such as, for example, one or more sensors, a context manager, a device state component, and/or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

In addition, the machine learning techniques described herein are readily interchangeable and combinable. Although certain example techniques have been described, many others exist and can be used in conjunction with aspects of the present disclosure.

A brief overview of example machine-learned models and associated techniques has been provided by the present disclosure. For additional details, readers should review the following references: Machine Learning A Probabilistic Perspective (Murphy); Rules of Machine Learning: Best Practices for ML Engineering (Zinkevich); Deep Learning (Goodfellow); Reinforcement Learning: An Introduction (Sutton); and Artificial Intelligence: A Modern Approach (Norvig).

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A system for intelligently identifying and recommending smart home products for a smart home environment, the system comprising:
a database comprising:
characteristic data from each existing user of a population of existing users, choice data from each existing user of the population of existing users, and performance metrics associated with the choice data for each existing user;
an artificial intelligence system having one or more processors and a memory having stored thereon instructions that, when executed by the one or more processors, cause the one or more processors to:
use supervised learning to:
generate at least one model based on the characteristic data, choice data, and performance metrics,
based on receiving notification of a triggering event comprising initial parameter data, the triggering event associated with a prospective user, identify a fitted model of the at least one model based on the initial parameter data, and
extract interview questions based on the fitted model; and
use reinforcement learning to:
map response parameters of the prospective user to characteristic data in the database to generate, using choice data and performance metrics associated with the mapped characteristic data, a product recommendation including one or more smart home products for the prospective user, wherein the response parameters include interview responses of the prospective user to the interview questions, and
upon receiving a success metric for the prospective user, update the database to include the prospective user in the population of existing users with characteristic data and choice data of the prospective user and to include the success metric as the performance metric associated with the choice data of the prospective user.

2. The system for intelligently identifying and recommending smart home products for the smart home environment of claim 1, the system further comprising:
a server having a server application stored on a memory of the server that, when executed by one or more processors of the server, cause the one or more processors to:
provide a user interface to interact with the prospective user;
transmit, via the user interface, the interview questions to a device of the prospective user;
receive, via the user interface, the interview responses from the prospective user;
provide the interview responses to the artificial intelligence system; and
transmit, via the user interface, the product recommendation of the one or more smart home products to the device of the prospective user.

3. The system for intelligently identifying and recommending smart home products for the smart home environment of claim 2, wherein the server application further causes the one or more processors to:
retrieve data about a neighborhood in which the prospective user lives; and
provide the data about the neighborhood in which the prospective user lives to the artificial intelligence system, wherein the response parameters further include the data about the neighborhood in which the prospective user lives.

4. The system for intelligently identifying and recommending smart home products for the smart home environment of claim 2, wherein a first interview question of the interview questions requests at least one image of a home of the prospective user, and wherein the server application further causes the one or more processors to:
analyze the at least one image to extract physical information about the home; and
provide the physical information about the home to the artificial intelligence system, wherein the response parameters further include the physical information about the home.

5. The system for intelligently identifying and recommending smart home products for the smart home environment of claim 1, wherein a first interview question of the interview questions requests demographic information.

6. The system for intelligently identifying and recommending smart home products for the smart home environment of claim 1, wherein choice data of a first existing user of the population of existing users comprises at least one of smart home devices used in a home of the first existing user and smart home services used in the home of the first existing user.

7. The system for intelligently identifying and recommending smart home products for the smart home environment of claim 1, wherein performance metrics associated with the choice data for a first existing user of the population of existing users comprises at least one of a usage metric associated with the choice data, a conversion metric associated with the choice data, a user satisfaction metric associated with the choice data, and a compliance metric associated with the choice data.

8. The system for intelligently identifying and recommending smart home products for the smart home environment of claim 1, wherein the product recommendation further includes a weighted score for each of the one or more smart home products for the prospective user, wherein the weighted score for each of the one or more smart home products is based on the performance metrics associated with the choice data and characteristic data mapped to the response parameters.

9. The system for intelligently identifying and recommending smart home products for the smart home environment of claim 1, wherein the product recommendation further includes an installation plan for the one or more smart home products.

10. The system for intelligently identifying and recommending smart home products for the smart home environment of claim 1, wherein the prospective user is a first user of the population of existing users and wherein the server application further causes the one or more processors to:
identify the prospective user in the population of existing users;
identify one or more smart home products used by the prospective user;
obtain behavior information of occupants of a home of the prospective user from the one or more smart home products; and
provide the behavior information to the artificial intelligence system, wherein the response parameters further include the behavior information.

11. The system for intelligently identifying and recommending smart home products for the smart home environment of claim 1, wherein the product recommendation further includes a listing of the one or more smart home products including a natural language explanation of features and benefits specific to addressing an issue identified in the initial parameter data.

12. The system for intelligently identifying and recommending smart home products for the smart home environment of claim 1, wherein the product recommendation further includes:
an installation location specific to a home of the prospective user for each of the one or more smart home products; and
a configuration specific to the home of the prospective user for each of the one or more smart home products.

13. The system for intelligently identifying and recommending smart home products for the smart home environment of claim 12, wherein the one or more smart home products comprises a smart home camera and a configuration for the smart home camera comprises a viewing angle for the smart home camera.

14. The system for intelligently identifying and recommending smart home products for the smart home environment of claim 1, wherein the product recommendation further includes:
an image of a home of the prospective user comprising a depiction of an installation location for each of the one or more smart home products.

15. A method for intelligently identifying and recommending smart home products for a smart home environment, the method comprising:
generating, by an artificial intelligence system using supervised learning, at least one model based on characteristic data, choice, data, and performance metrics, wherein the characteristic data is for each of a population of existing users, the choice data is for each of the population of existing users, and the performance metrics are associated with the choice data for each existing user;
identifying, by the artificial intelligence system, based on receiving notification of a triggering event comprising initial parameter data, the triggering event associated with a prospective user, a fitted model of the at least one model based on the initial parameter data;
extracting, by the artificial intelligence system, interview questions based on the fitted model;
mapping, by the artificial intelligence system, response parameters of the prospective user to characteristic data to generate, using choice data and performance metrics associated with the mapped characteristic data, a product recommendation including one or more smart home products for the prospective user, wherein the response parameters include interview responses of the prospective user to the interview questions; and
upon receiving a success metric for the prospective user, updating, by the artificial intelligence system, the database to include the prospective user in the population of existing users with characteristic data and choice data of the prospective user and to include the success metric as the performance metric associated with the choice data of the prospective user.

16. The method for intelligently identifying and recommending smart home products for the smart home environment of claim 15, the method further comprising:
providing, by the artificial intelligence system, a user interface to interact with the prospective user;
transmitting, via the user interface, the interview questions to a device of the prospective user;
receiving, via the user interface, the interview responses from the prospective user; and
transmitting, via the user interface, the product recommendation of the one or more smart home products to the device of the prospective user.

17. The method for intelligently identifying and recommending smart home products for the smart home environment of claim 16, the method further comprising:
retrieving, by the artificial intelligence system, data about a neighborhood in which the prospective user lives; and
providing, by the artificial intelligence system, the data about the neighborhood in which the prospective user lives to the artificial intelligence system, wherein the response parameters further include the data about the neighborhood in which the prospective user lives.

18. The method for intelligently identifying and recommending smart home products for the smart home environment of claim 16, wherein a first interview question of the interview questions requests at least one image of a home of the prospective user, the method further comprising:
analyzing, by the artificial intelligence system, the at least one image to extract physical information about the home; and
providing, by the artificial intelligence system, the physical information about the home to the artificial intelligence system, wherein the response parameters further include the physical information about the home.

19. A computer readable device, having instructions thereon for intelligently identifying and recommending smart home products for a smart home environment that, when executed by one or more processors, cause the one or more processors to:
generate at least one model based on characteristic data, choice, data, and performance metrics, wherein the characteristic data is for each of a population of existing users, the choice data is for each of the population of existing users, and the performance metrics are associated with the choice data for each existing user;
identify, based on receiving notification of a triggering event comprising initial parameter data, the triggering event associated with a prospective user, a fitted model of the at least one model based on the initial parameter data;
extract interview questions based on the fitted model;
map response parameters of the prospective user to characteristic data to generate, using choice data and performance metrics associated with the mapped characteristic data, a product recommendation including one or more smart home products for the prospective user, wherein the response parameters include interview responses of the prospective user to the interview questions; and
upon receiving a success metric for the prospective user, update the database to include the prospective user in the population of existing users with characteristic data and choice data of the prospective user and to include the success metric as the performance metric associated with the choice data of the prospective user.

20. The computer readable device of claim 19 having stored thereon further instructions that, when executed by the one or more processors, cause the one or more processors to:
provide a user interface to interact with the prospective user;
transmit, via the user interface, the interview questions to a device of the prospective user;
receive, via the user interface, the interview responses from the prospective user; and
transmitting, via the user interface, the product recommendation of the one or more smart home products to the device of the prospective user.
